(19) United States
(12) Patent Application Publication
(10) Pub. No.: US 2020/0268592 A1
(43) Pub. Date: Aug. 27, 2020

(54) ADAPTIVE COMPRESSION THERAPY SYSTEMS AND METHODS

(71) Applicant: RADIAL MEDICAL, INC., Woodside, CA (US)

(72) Inventors: Eric JOHNSON, Woodside, CA (US); Thomas J. FOGARTY, Portola Valley, CA (US); Sylvester LUCATERO, East Palo Alto, CA (US); Gilbert LAROYA, Santa Clara, CA (US); James K. WALL, San Francisco, CA (US); Conrad SALINAS, Santa Clara, CA (US)

(21) Appl. No.: 16/759,396

(22) PCT Filed: Oct. 26, 2018
(86) PCT No.: PCT/US2018/057778

§ 371 Date: Apr. 27, 2020

Related U.S. Application Data
(60) Provisional application No. 62/577,643, filed on Oct. 26, 2017.

(51) Int. Cl. A61H 11/00; A61H 1/00

(52) U.S. Cl. CPC A61H 11/00; A61H 1/00; A61H 2011/005; A61H 2209/00; A61H 2201/5097; A61H 2201/5046; A61H 2201/5082; A61H 2201/5084; A61H 2201/501; A61H 2201/5061; A61H 2201/5064; A61H 2201/5071; A61H 2201/0111

(57) ABSTRACT

Systems, devices and methods for providing active and/or passive compression therapy to a body part can include a compression device worn over a compression stocking The compression device can have a pulley based drive train that is driven by a motor to tighten and loosen compression elements, such as compression straps, in a precise, rapid, and balanced manner. Sensors can be used in the compression device and/or compression stockings to provide feedback to modulate the compression treatment parameters.

### CROSS REFERENCE TO RELATED APPLICATIONS

This application claims the benefit of U.S. Provisional Patent Application No. 62/577,643, filed on Oct. 26, 2017, the disclosure of which is incorporated by reference in its entirety.

This application may be related to U.S. application Ser. No. 15/499,846, filed on Apr. 27, 2017, and U.S. application Ser. No. 15/499,850, filed on Apr. 27, 2017, each of which is herein incorporated by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### FIELD

Embodiments of the invention relate generally to systems and methods to provide compression therapy to a body part, and more specifically, to systems and methods to provide active and/or adaptive compression therapy to a body part.

### BACKGROUND

Compression therapy (CT), is the selective external compression of a portion of the body using wraps, stockings, inflatable cuffs and bandages. CT can be either passive compression using elastic or inelastic bandages or multiple layers of bandages (no external energy applied) or active, where an external energy source augments a compressive force applied to body part(s), as shown in FIGS. 1A-E. CT is used to treat many conditions including: vascular insufficiency (both arterial and venous) as shown in FIG. 2, lymphedema, post thrombotic syndrome, DVT prophylaxis, post op pain/swelling, leg swelling, varicose veins, enhance blood circulation, intermittent claudication, inoperative peripheral arterial disease, post-operative swelling, congestive heart failure, sport/exercise recovery, and massage.

Examples of the some of the commercially available compression bandages currently available include those made by 3M, BSN Medical, Convatec, Derma Sciences, Hartman group, Kendall/Covidien, Lohmann and Rauscher, Medline Industries, and Smith and Nephew. The compressive force of compression bandages is achieved in the application or wrapping of the bandage by a caregiver. The consistency of the compression is dependent on the skill of the caregiver applying the bandage. There is no feedback on the amount of compressive force applied with bandages. The patient is wears the bandage until the stocking loses its compliance or become soiled. Bandages are typically applied to the arms or legs.

Compression stockings (CS) are elastic stockings that are typically placed over the lower leg like long length sock or leg hosiery. The stockings are marketed to provide a specific level of compression, often greater compression at the ankle with reducing levels of compression toward the knee to compensate for the higher hydrostatic pressure toward the ankle when standing.

CS can be designed to provide a range of pressures to the lower leg. For example, a CS that delivers light compression can provide less than 20 mmHg of pressure; moderate compression is between 20 to 40 mmHg, strong compression between 40 and 60 mmHg and very strong compression can be over 60 mmHg.

Manufacturers offer a variety of compression levels up to 60 mmHg. Some manufacturers of CS include Bauerfeind, BSN, Kendell/Covidien, and Sigvaris.

Active compression (AC), often referred to as pneumatic compression devices use air chamber containing sleeves that enclose the patient's leg or foot. The three main categories of AC are foot pumps, that compress the venous sinus of the foot, intermittent pneumatic compression (IPC) that inflate and deflate the entire sleeve at the same time and sequential compression pumps (SC) that sequentially inflate chambers in the sleeve to move the blood (or milk) the blood toward the foot to enhance arterial flow, or toward the waist to improve venous, lymphatic fluid or enhance removal of lactic acid post-exercise.

AC devices are made in both plug-in and battery-powered mobile units as shown in FIG. 2. With the exception of the Venowave, which uses a roller to roll the calf, the pneumatic compression devices typically operate in the same manor. A pneumatic pump fills a bladder or series of airtight bladders that is controlled via a console.

There is strong evidence that all these forms of compression therapy are helpful in treating or preventing the conditions for which they are used. The significant deficiencies that all of these technologies suffer from is unknown/inconsistent pressure application, poor comfort due to bulky, non-breathable cuffs and difficulty in donning/doffing the stockings or wraps. These design deficiencies result in non-compliance with the technologies, estimated to be as high as 70%. The root cause for poor compliance with compression therapy is multi-factorial. Standard tight fit stockings are hard to don/doff for someone who already has limited mobility due to their disease. Some clinicians resort to recommending that patients apply KY jelly over the leg to help don/doff the stocking, as well as using an external donning/doffing aid, such as a Jobst Stocking Donner (Model number 110913). In addition, although these stocking can be provided in multiple sizes, too the stockings often have problems with poor fit, including areas that are too tight causing pain or too loose causing the stocking to droop. Inelastic compression wraps (e.g. Unna boot) where the lower leg is wrapped in a series of layers of cotton wraps with zinc oxide and other compounds, are not well tolerated by patients either as they are rigid, uncomfortable, can develop a foul smell due to accumulation of exudates from the ulcer and must be changed weekly. Inelastic compression wraps have an additional burden as compression wraps must be changed often, which typically requires the patient to travel to a venous clinic and utilizes expensive nursing resources.

With millions of affected patients affected in the US and billions of dollars spent attempting to treat patients with poorly understood treatment regimens with devices that patients are reticent to use due to discomfort, there is clearly a need for a better technology. Therefore, there is a need for an innovative, multi-mode compression therapy system that addresses these problems.

### SUMMARY OF THE DISCLOSURE

The present invention relates generally to systems and methods to provide compression therapy to a body part, and more specifically, to systems and methods to provide active and/or adaptive compression therapy to a body part.

In a first aspect, a system for providing compression therapy to a body part of a user is provided. The system comprises a wearable compression device, the wearable compression device comprising: a drive unit configured to be placed over or against a body part, the drive unit comprising; one or more motors; a controller configured to control operation of the one or more motors; a power source in electrical communication with the one or more motors and the controller, one or more compression members configured to be wrapped at least partially around a portion of the body part, wherein the one or more compression members are configured to be tensioned by the one or more motors; and a housing configured to enclose the one or more motors, the controller, and the power source.

The system can comprise a handheld computing device configured to communicate with the wearable compression device. The handheld computing device can be a smartphone. In some embodiments, the handheld computing device has a touch screen user interface.

The touchscreen user interface can comprise a display with a plurality of graphical icons along an edge of the display. In some embodiments, the graphical icons each link to a unique screen. The unique screens can include a prescription screen, wherein the prescription screen is configured to allow one or more treatment parameters to be set by the user. In some embodiments, the unique screens include a user treatment screen configured to allow the user to initiate, stop, and/or adjust treatment. The wearable compression device can comprise one or more sensors, wherein the unique screens further include a treatment data screen configured to graphically display data collected by the one or more sensors. The unique screens can include an alerts screen. The unique screen can include a user compliance screen.

The touchscreen user interface can have a photo section configured to allow for uploading of user photos. In some embodiments, the touchscreen user interface comprises a user feedback section configured to allow a user to provide feedback regarding treatment. The touchscreen user interface can comprise a notes section configured to allow for adding and viewing of notes. In some embodiments, the unique screen includes a treatment screen showing treatment status, treatment progress, and allows treatment control. The unique screens can include a history screen showing historical treatment and/or compliance information. In some embodiments, the unique screens include an account screen showing patient information and account settings.

The device can comprise a communications module. In some embodiments, the device is configured to send data regarding treatment, compliance, efficacy and/or sensor data to a remote database.

In some embodiments, the system comprises a clinician interface configured to display the data received from the device. The clinician interface can comprise an app or other software based program. The clinician interface can allow for viewing of sensor and compliance data from one or more wearable compression devices. In some embodiments, the clinician interface allows for entry or updating of prescription information. The clinician interface can allow for sending messages and alerts to the user.

In some embodiments, the system comprises a processor configured to receive and analyze treatment data from a plurality of users and recommend a specific treatment protocol for a specific user based on the specific user's information.

The device can comprise a force sensor configured to measure force in a body part. In some embodiments, a processor receiving data from the force sensor is configured to detect a deep vein thrombosis in a user based on data received from the force sensor. The system can be configured to produce an alert upon detection of the deep vein thrombosis.

In some embodiments, the device comprises a vibrating element. The device can comprise an accelerometer. In some embodiments, the wearable compression device comprises a cushioned cradle surrounding at least a portion of the housing. The one or more compression members can extend through or over the cradle. In some embodiments, a resilient and waterproof boot enclosure is positioned between each strap and the cradle. In some embodiments, a force sensor and/or vibrating element are positioned on a back surface of the housing. The cradle can comprise a recessed portion configured to receive a back surface of the housing.

In some embodiments, the straps are reversibly secured together using one or more magnetic clasps. Each clasp can comprise a male portion on a first strap and a female portion on a second strap. In some embodiments, the male portion comprises an overhang configured to be secured in an undercut of the female portion. In some embodiments, a cushioned backing component is positioned around the magnetic clasp on each strap, the cushioned backing component configured to be positioned between the user's skin and the magnetic clasp during use. The male portion can be configured to lock into the female portion when a circumferential tension is applied, and wherein the male portion is configured to be removed from the female portion by the application of inward radial force on the magnetic clasp.

In some embodiments, the device comprises a plurality of pulleys, one or more drive elements configured to be tensioned by the one or more motors, wherein the one or more drive elements are threaded around the plurality of pulleys. The one or more compression members can be attached to the pulleys and configured to be tensioned by the pulleys.

In some embodiments, the one or more compression members includes a safety breakaway feature that is configured to break apart when subjected to a predetermined amount of force. The safety breakaway feature can be a breakable clasp.

In another aspect, a device for providing compression therapy to a body part of a user is provided. The device comprises a drive unit configured to be placed over or against a body part, the drive unit comprising; one or more motors; a controller configured to control operation of the one or more motors; a power source in electrical communication with the one or more motors and the controller; and a plurality of pulleys; one or more drive elements configured to be tensioned by the one or more motors, wherein the one or more drive elements are threaded around the plurality of pulleys; one or more compression mechanisms configured to be wrapped at least partially around a portion of the body part, wherein the one or more compression mechanisms are attached to the pulleys and are configured to be sequentially tensioned by the pulleys; and one or more boot enclosures, each boot enclosure enclosing a portion of the one or more drive elements, wherein the one or more boot enclosures are configured to take up slack in the one or more drive elements.

In another aspect, a method for applying mechanical compression therapy to a body part of a user is provided. The method comprises placing a device on the body part of the user, the device comprising one or more motors, a controller configured to control operation of the one or more motors, a power source in electrical communication with the one or motors and the controller; wrapping straps of the device at least partially around the body part of the user; removably securing the straps together; and causing the controller to activate the device, thereby applying mechanical compression therapy to the body part.

In some embodiments, the applying mechanical compression therapy comprises powering the one or more motors, thereby applying tension to one or more compression members. Applying tension to one or more compression members can comprise tensioning one or more drive elements using the one or more motors, wherein the one or more drive elements are threaded around a plurality of pulleys and connected to the one or more compression members. In some embodiments, causing the controller to activate the device comprises using a user interface on the device or on an app or program in electrical communication with the device.

The method can comprise causing the controller to send data regarding treatment, compliance or sensor data received from sensors positioned on the device to a remote database. In some embodiments, the method comprises monitoring force in the body part using a force sensor on the device. The method can comprise a processor receiving data from the force sensor; processing the data using a processor; and executing algorithms on the processor configured to detect a deep vein thrombosis from the data.

In some embodiments, the method comprises sensing periodic limb movements using an accelerometer. The method can comprise the controller initiating treatment based on sensing periodic limb movements. In some embodiments, the method comprises causing the controller to activate a vibrating element on the device. The method can comprise the controller initiating compression and/or vibration based on sensing periodic limb movements. In some embodiments, the method comprises the controller stopping the device.

The method can comprise uploading user data using an app or program in electrical communication with the device. In some embodiments, the method comprises storing user data, treatment data, and/or compliance data in a remote database. The method can comprise generating recommended therapy protocols based on the stored data. In some embodiments, the data is received from a plurality of users and devices. The method can comprise zeroing the device to a baseline condition.

In yet another aspect, a method of monitoring a patient for deep vein thrombosis (DVT) is provided. The method comprises wrapping a compression device comprising a controller, a motor, and one or more compression members at least partially around a calf of a patient, the compression device comprising a force sensor positioned such that it is configured to measure tension in the patient's calf; causing the controller to activate the device to apply compression and measure the tension in the patient's calf; and using a processor to process data received from the force sensor, the processor configured to recognize data from the force sensor corresponding to development of a DVT in the patient.

In some embodiments, the method comprises the processor detecting a DVT. The method can comprise adjusting treatment applied by the compression device upon detection of the DVT. In some embodiments, the method comprises producing an alert upon detection of the DVT.

In another aspect, a method of monitoring a patient for onset of symptoms of restless leg syndrome is provided. The method comprises wrapping a device comprising a controller, a vibrating element, a motor, and one or more compression members in communication with the motor and configured to apply compression, at least partially around a portion of a leg of a patient, the device comprising an accelerometer; causing the controller to activate the accelerometer to monitor movement of the patient's leg; and using a processor to receive data from the accelerometer, the processor configured to recognize data corresponding to periodic limb movements of the patient.

In some embodiments, the method comprises the processor recognizing periodic limb movements of the patient. The method can comprise initiating compression therapy upon detection of periodic limb movements. In some embodiments, the method comprises initiating vibration therapy upon detection of periodic limb movements. The method can comprise modulating ongoing therapy upon detection of periodic limb movements.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIGS. 1A-1E illustrate various passive and active compression therapy devices.

FIG. 2 illustrates vascular insufficiency caused by deformed or defective valves in a blood vessel, such as a vein.

FIGS. 3A-3C illustrate an embodiment of a compression device.

FIG. 4 illustrates an embodiment of a compression stocking with integrated compressive elements.

FIGS. 5A and 5B illustrate how physical stops can be used to align the movable pulleys in a pulley based drive train.

FIGS. 6A-6J illustrate various embodiments of closure and compression mechanisms that can be used to fasten the compression device to a body part.

FIGS. 6K-6N illustrate an embodiment of a compression device with a magnetic closure mechanism.

FIG. 6O illustrates an embodiment of another magnetic closure mechanism.

FIGS. 7A-7C illustrate various embodiments of a compression plate.

FIG. 7D illustrates an embodiment of a cover that can be placed over the compression plate to enclose the components of the compression device.

FIG. 7E illustrates an embodiment of a modular compression system with multiple compression devices that can be in communication to provide coordinated compression therapy.

FIGS. 8A-8E illustrate various drive train configurations to achieve one or more compression zones.

FIGS. 9A and 9B illustrate embodiments with increased mechanical advantage.

FIG. 10A illustrates another embodiment of a pulley based drive train.

FIGS. 10B and 10C illustrate various embodiments of ways a compression device can be attached to a compression stocking.

FIG. 11 illustrates an embodiment of a user interface on a smart phone.

FIG. 12 illustrates an embodiment of a flow chart that sets forth the communication, flow of information and data, and/or connections between the various components of the system.

FIGS. 13A-13C illustrate exemplary data that can be accessed by the user and/or authorized parties.

FIGS. 14A-14C illustrate an example of a breakable safety feature.

FIGS. 15A-15C illustrate an example of an inductive charger that can inductively charge the compression device.

FIGS. 16A-16F illustrate various examples of a user interface.

FIGS. 17A-19C illustrate various examples of compression devices that are particularly suited for sports recovery applications.

FIGS. 20A and 20B illustrate venous blood velocity profiles in the lower leg that are achieved by various means.

FIG. 21 is an exemplary compression device on, in or within a sleeve of a jacket.

FIG. 22 is an exemplary compression device on, in or within the leg of pants.

FIGS. 23A-23E illustrate various slack management features of the compression device.

FIGS. 24A-24D illustrate one way of attaching the foam pad to the compression plate.

FIGS. 25A-C illustrate an example of a force sensor and pads on a compression device.

FIGS. 26A-E illustrate various views of an example of a compression device.

FIGS. 27A and 27B depict various views of an example of a boot enclosure on a compression device.

FIGS. 28A-28D illustrate various views of an example of a closure mechanism on a compression device.

FIGS. 29A-30B illustrate various example screens of an app or program that can be used with a compression device.

FIGS. 31A and 31B are exemplary data streams that can be received from a compression device.

FIGS. 32A-32C illustrate various example screens of an app or program that can be used with a compression device.

FIGS. 33A-G also illustrate various example screens of an app or program that can be used with a compression device.

FIG. 34A illustrate an exemplary compression device.

FIG. 34B shows exemplary compression cycles with and without a DVT.

FIGS. 35A and 35 B show exemplary accelerometer data of normal sleep and sleep with periodic limb movements.

FIGS. 36A-36E depict data from a study comparing a mechanical compression device to commercially available pneumatic devices.

FIG. 37 also depicts data from a study comparing a mechanical compression device to a pneumatic compression device.

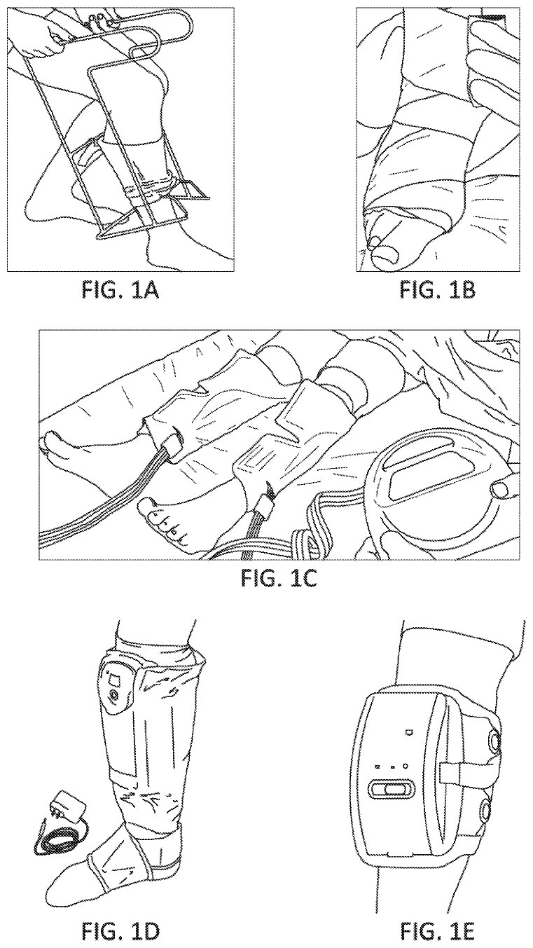

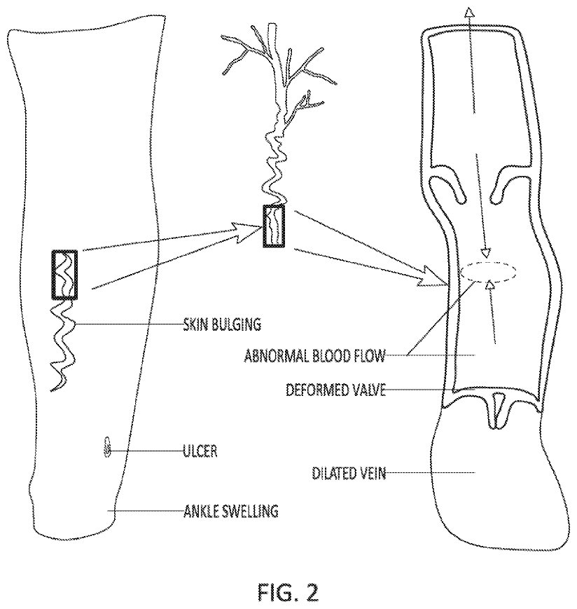

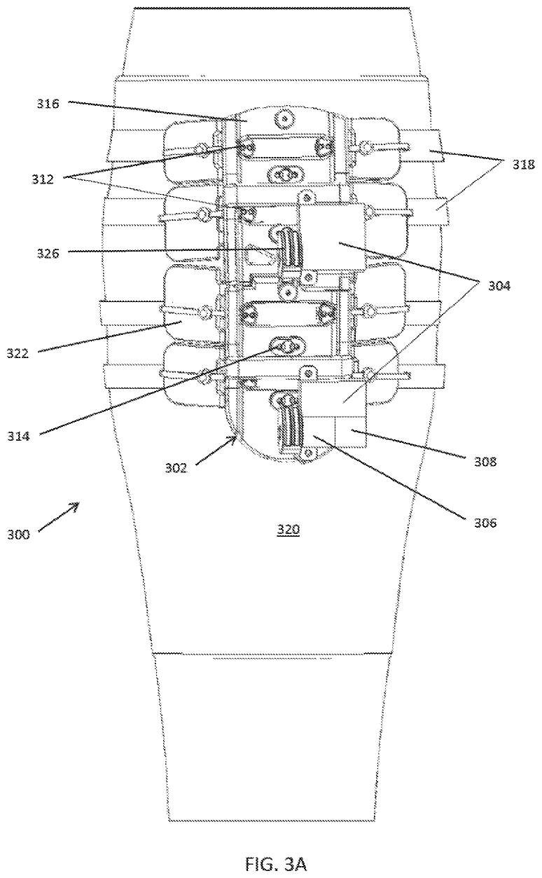

### DETAILED DESCRIPTION

Described herein are systems, devices, and methods that make compression therapy comfortable, consistent, easy to use, and customized to increase compliance with a proven therapy. In addition, the use of an effective, low profile, mechanical drive system in combination with modern sensing, data management and remote interface enables the system to add functionality that will improve outcomes. The basis of the system is the mechanical tensioning and coordination of therapy among multiple compression bands around a part of the body. The system is further enabled by sensors, mechanical feedback, and user input that enable real-time monitoring, adjustments and adaptation to the individual patients' anatomy, physiology, tolerance, and therapeutic needs. Finally, the unique data streams from this device including mechanical, physiological, imaging, and patient feedback data can be leveraged on both an individual and population basis with analytics and artificial intelligence in order to optimize therapy for both individuals and populations.

Described herein are systems, devices, and methods that enable both standard compression and active therapy in a mobile, lightweight, breathable, simple interface that encourages compliance with remote monitoring capability. Additional features of strain gauge plethysmography, tilt sensing, compliance and remote monitoring are included to facilitate better outcomes through accumulation of a large database of treatment outcomes. Various embodiments include a “smart” stocking that can use real time data and proprietary algorithms in order to implement customized treatment that learns and adapts to the specific patient needs and disease state progression.

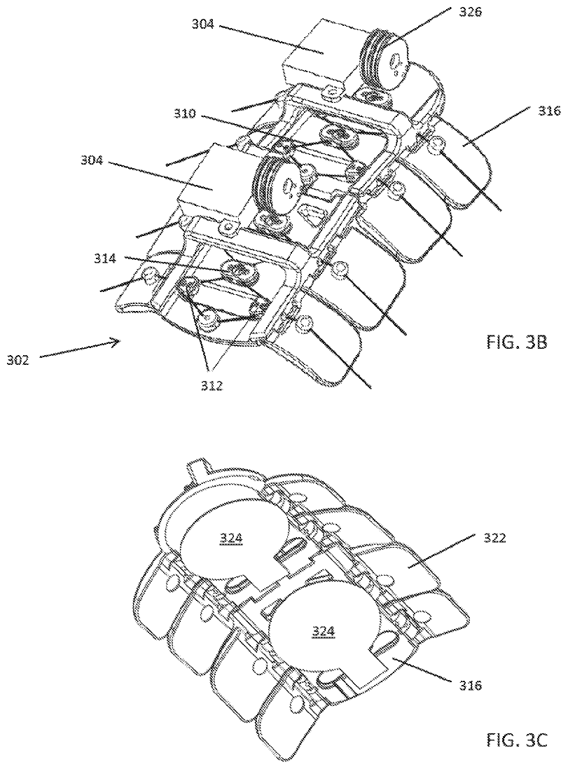

In some embodiments, as shown in FIGS. 3A-3C the basic components of the compression systems 300 include a compression device 302 that includes one or more geared motor(s) 304, a power source (e.g., a battery) 306, an electronic control board 308 with processor(s) and memory, wireless capability, a force transmission drivetrain that may be pulley based and include a drive cord 310 and both movable pulleys 312 and fixed pulleys 314 that are fixed on a compression plate 316, compression transmission components 318, a calf understocking 320, padding 322, an attachment mechanism, an ankle compressive understocking, a remote control system, and various sensors 324 and diagnostic components such as a pressure sensor and accelerometer, for example. The motor(s) 304 rotate a drive pulley 326 on which the drive cord 310 is attached.

Alternative drive trains that may be pulley-less include using twisted pairs of drive cords that are attached on one end to the compression strap or mechanism, as described in U.S. Patent Publication No. 2008/0066574, for example. The other end of the twisted pair actuator can be attached to a motor that can twist the pair of drive cords to shorten the twisted pair and generate force and compression, and the motor can untwist the twisted pair to lengthen the twisted pair to reduce the force and compression. Yet another pulley-less drive train can include directly attaching the drive cord to the compression strap or mechanism and omitting the pulleys.

For example, the system can include the parts and features listed below in Table 1.

TABLE 1

| Component | Purpose/Function |
|---|---|
| Compression | Delivers compression to select zone under plate |
| Plate | |
| Electronic | Controls motor position, rotation, speed, wireless |
| control | communication, data acquisition and storage |
| system | |
| Battery/Energy | Provide power for motor and electronics. Could be |
| source | rechargeable battery, kinetic system, inductive |
| | charging, charged from heating of leg, |
| Motor | Brushed or brushless servomotor. Lead screw motor, |
| | solenoid, |
| Drive Shaft | Circular or cam shape to spool drive cord. |
| Compression | Straps or integrated inelastic cords woven into |
| straps | elastic stocking. |
| Compression | Flexible, adaptable elements to transmit force to |
| wings | leg. Could be actively powered compressive |
| | elements. |
| Compression | Moveable pulley. Translate force from motor to hoop |
| strap pulley | of compression strap system |
| Compression | Fixed pulley on compression plate. |
| plate pulley | |
| Gauges | Integrated into compression plate chassis. Strain, |
| | accelerometer, temperature, light, gas, |
| Stocking | Woven, knit, electrospun or laminate stocking to |
| | cover appendage, provide indexed attachment for |
| | active system. Stocking could also have tension |
| | elements interwoven, attached with passive system |
| | to maintain constant tension. Anti-microbial |
| | (eg merino wool, silver fibers). Breathable, |
| | washable, disposable. |
| Padding, | Clamshell, over the foot, circular or linear |
| attachment | ratchet, Boa, |
| mechanism | |

In summary, a motor turns a drive shaft with a drive pulley. The drive pulley spools a drive cord threaded through a pulley based drivetrain, which includes both compression plate pulleys that are fixed on a compression plate and movable compression strap pulleys that transmit force from the motor to a compression strap system. Tension is applied to the compression straps as the drive pulley spools the drive cord, and tension is released by reversing the motor and the rotation of the drive shaft and the attached drive pulley, thereby allowing the drive cord to unspool. In addition, the compressed leg or other body part naturally provides a reactive force that promotes unspooling and unloading. In some embodiments, a resilient element may be used to supplement the reactive force provided by the compressed body part, as described in further detail below.

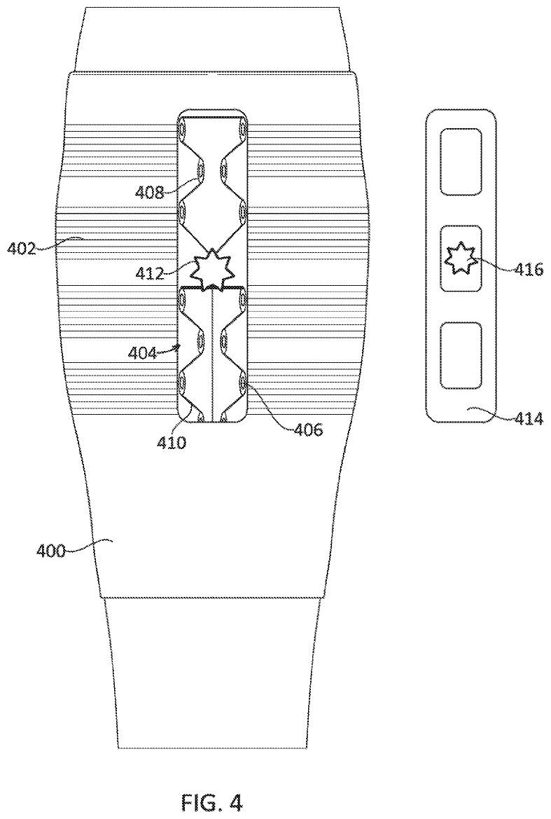

The system will now be described in more detail. As shown in FIG. 4, the understocking(s) 400, also referred herein as compression stockings or sleeves, are placed on desired appendage or body part, such as the arm, leg, foot, hand, toe, finger, or chest. The understockings 400 may have integrated active and/or passive compression/tensioning mechanism(s) 402, such as inelastic threads, wires, and/or cords that are woven into the stocking fabric or material, interwoven strain gauge or other gauges or sensors (e.g., temperature, O2, ultra sonography), integrated adjunctive therapy delivery (e.g., light, LEDs, drugs, sound waves, gas, electrical muscle stimulation, heating, cooling), and/or be constructed of antimicrobial materials (e.g., silver or superfine merino wool, etc.). The stocking can include a pulley based drive train 404 as described herein that may include movable pulleys 406 and fixed pulleys 408 and a drive cord 410 attached to a drive pulley 412. The drive pulley can have an interface that can be coupled to a drive unit 414 with a motor 416 having a complementary interface for coupling with the interface of the drive pulley 412. The drive unit can include electronics, the user interface, the battery, and other components that when combined with the stocking form a complete compression device. The understockings can be made of transparent or partially transparent materials to enable visibility to the treatment zone (e.g. wound areas) and/or light therapy to be administered in conjunction with compression therapy. The compression stocking can have prescribed or predetermined openings, zones, areas, or sections, such as one or more flaps, that can be removed, unzipped or otherwise opened to provide access underneath the stocking, such as for wound exposure prior to and/or while treatment is being provided for the wound and/or to provide access for a sensor to contact the patient's skin. The compression stocking can have one or more active/passive components to enhance breathability, such as including a fan, pores, and material design such as wicking materials. The stocking can include a negative pressure therapy component for wound healing that can be actively powered and/or monitored by the system. For example, the motor can drive a pump that generates negative pressure in a sealed wound dressing placed over the wound. The stocking construction design may provide active and/or passive compression without the addition of an additional optional active unit that would be included in a smart stocking to maintain/monitor baseline pressure and compliance, as further described herein. The stocking, which may provide either active or passive compression, may collect data from integrated sensor(s) and change shape or configuration in response. The compression stocking can be made from materials incorporating one or more of the following: non-wovens, knits, wovens, extrusions, additive manufactured components, electronics, metallic, polymeric, natural materials. These materials (woven, knit, additive manufacturing) can be an integrated into a wearable component capable of providing compression therapy and other therapies. To increase the ease of putting the stockings on, a zipper, hook and/or loop or other adjunctive attachment mechanisms and methods may be used to place the stocking over the body part; for example, the stocking can be placed over the body in an open condition, and then the attachment mechanism closed or affixed to achieve a closed condition. In some embodiments, the attachment mechanism is configured to fastened or clasped together over the shin to provide ease of access to the user. In addition, multiple elastic understockings that can be easily put on may be overlapped in one or more area(s) to achieve a combined higher degree of compression in overlapped regions. Furthermore, placement of two or more compression therapy components, such as the stockings and other components of the system, can provide treatment either synergistically or independently. In some embodiments, the understockings can provide minimal compression, such as less than 15, 10, or 5 mmHg and can function primarily to assist in aligning and positioning the compression device onto the patient, as described below.

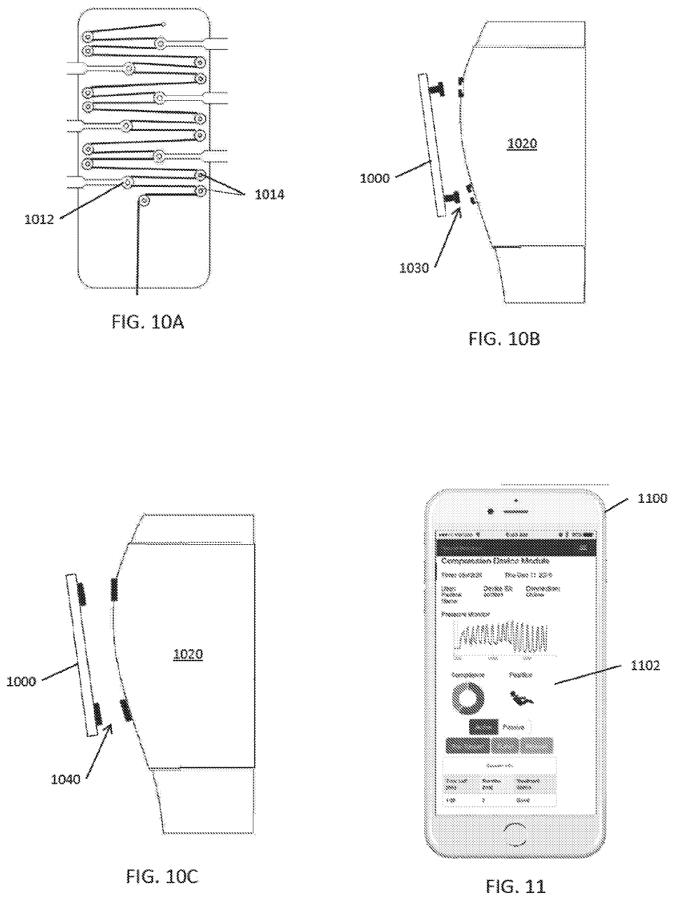

The compression plate/active compression assembly can be indexed, aligned and positioned properly on and around the stocking by aligning the compression plate/active compression assembly with index markers or patterns on the compression stocking and/or attachment to a compression stocking attachment that is integrated on the stocking. As shown in FIGS. 10B and 10C for example, indexing can utilize a visual, mechanical, magnetic, or electronic mechanism and/or method to attach the active components of the system to the passive compression stocking using a fastening mechanism such as hook & loop, plug, snap, magnet, strap, and/or slot. In some embodiments, the system provides active instructions and/or feedback regarding proper placement of the stocking on the body part and proper placement of the active control unit on the stocking. Sizing of the stocking can be determined by measurement of the length and circumference of the lower leg or body part to be compressed.

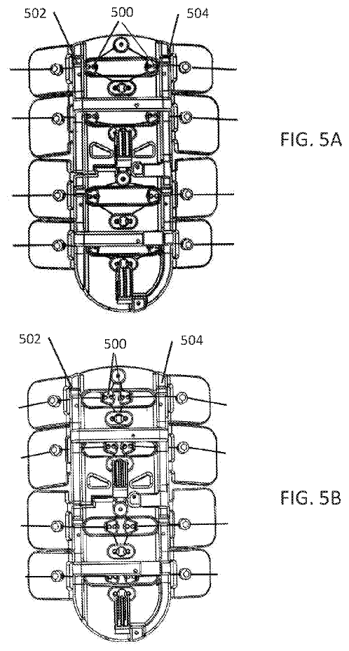

The active components of the system can index or zero itself to establish a reliable and consistent baseline configuration before initiating active compression therapy, as shown in FIG. 5A. This can be accomplished by seating or positioning the drive bearings 500, also referred to as the movable pulleys or the compression strap pulleys, in a “zero” position against hard stops 502, 504 along the outside edges of both sides of the compression plate at the start of a compression stroke cycle. Having stops on both sides of the compression plate prevents the movable pulleys 500 from becoming off-centered, which could result in undesired torque applied to the body part during the compression cycle. With the stops 502, 504, the movable pulleys 500 can be reliably positioned at the proper locations at the beginning of the compression cycle, allowing the system to provide a balanced, reliable and consistent amount of active compression to the body part, as shown in FIG. 5B. Zeroing the system to a baseline condition can be defined and/or controlled by mechanical means, features, or mechanisms, which may also provide a limit, which may be predetermined, to the travel of the movable pulleys along the compression plate. For example, the system can have mechanical hard-stops that limit the travel of the movable pulleys/compression strap pulleys along the compression plate and function to align the movable pulleys. If the stops are placed along the edges of the compression plate, the movable pulleys can travel to the edge of compression plate before the stop prevents further movement. This simple method/mechanism of zeroing the movable pulleys decouples the attachment method from the active compression method by setting the pulley travel position to a “zero” position regardless of the method used to affix the system to the body part. In some embodiments, no electronic charging or powering of the system is required to set system to zero point; the system may be mechanically adjusted by the user such that the movable pulleys are at the zero positions. In some embodiments, the act of putting on the device and fastening the device to the body part will automatically pull the movable pulleys against the stops and result in the movable pulleys being positioned at the zero position.

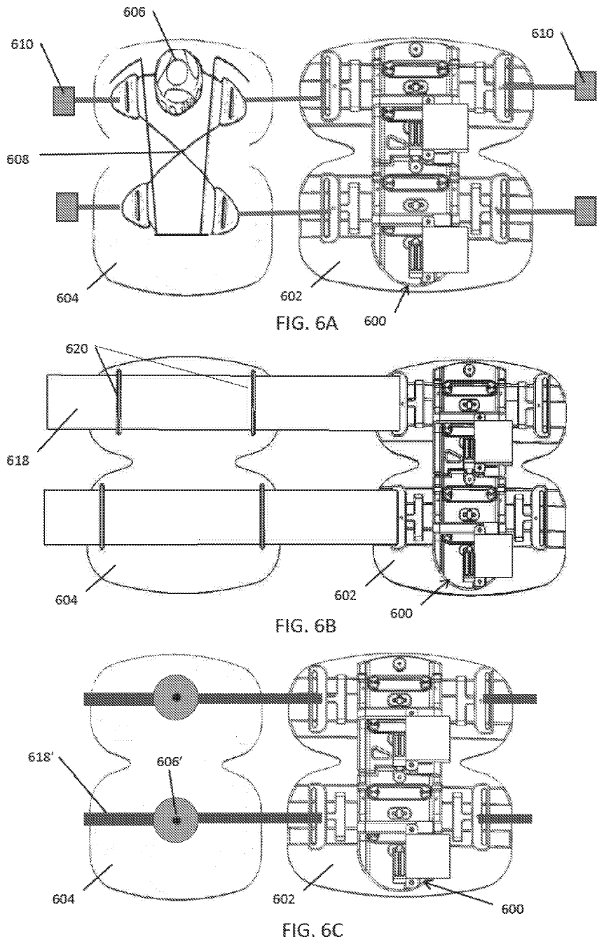

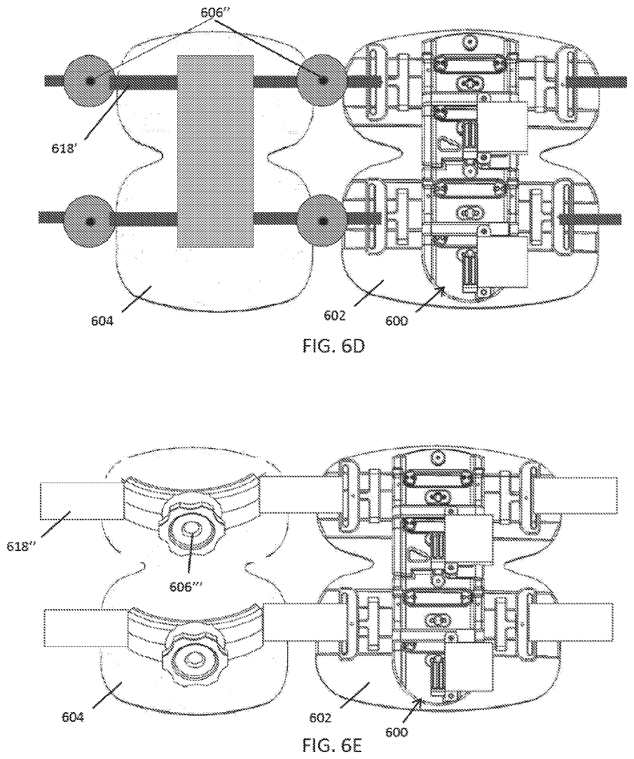

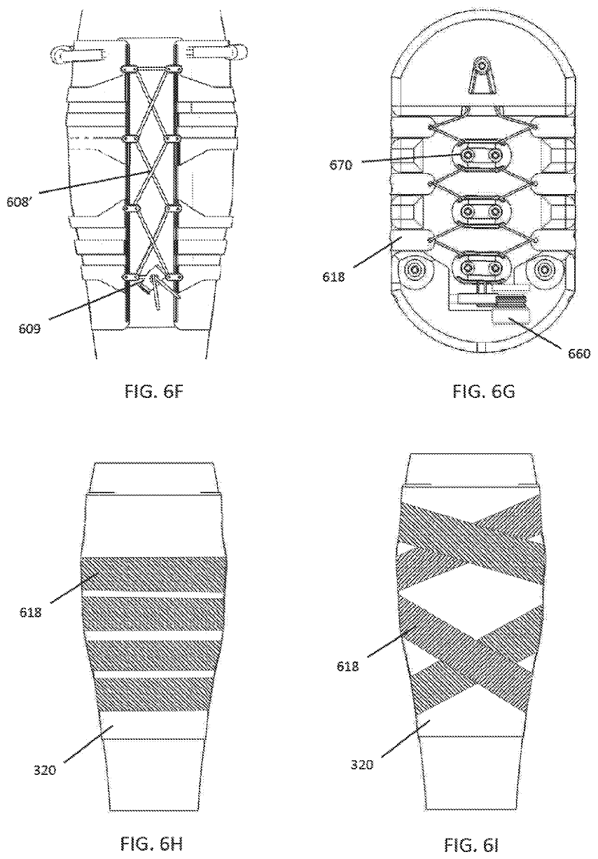

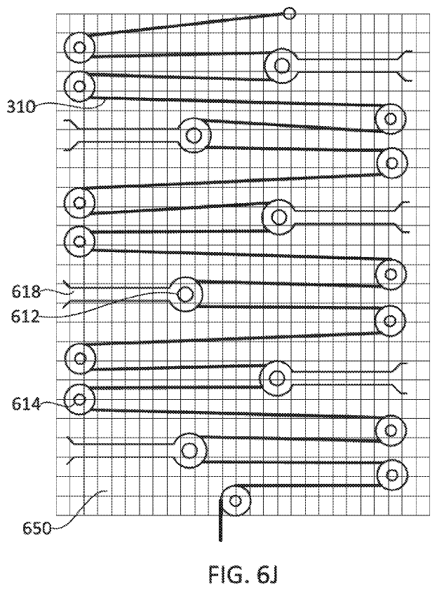

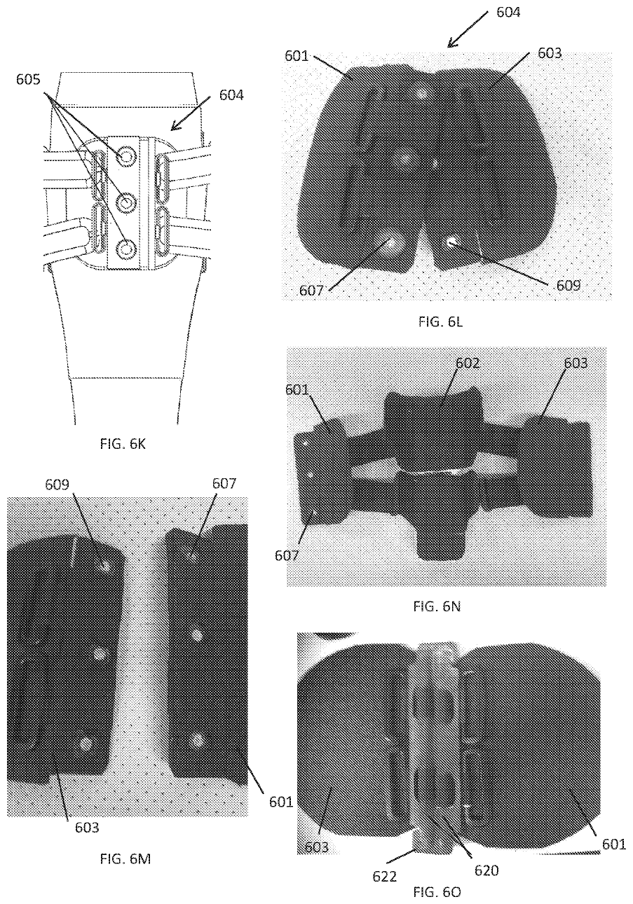

The compression straps of the system, as shown in FIGS. 3A, 6G, and 6H for example, may be pre-tensioned to a custom patient specific compression strap index location. The straps can include a visual and/or mechanical indication on the tensioning system, such as markings on the straps, to indicate appropriate zone of pre-tensioning. Alternatively, a pressure sensor, force sensor or strain gauge can be used to measure the tension and an indicator, such as an audible sound or LED light, can indicate to the user that the correct level of tension has been reached. In some embodiments, the independent compression straps 618 can cross over each other at various location(s) to create area(s) of enhanced compression, as shown in FIG. 6I. The tension applied to the compression straps may be generated through the mechanical advantage provided by pulleys, gears, and/or multiple pulleys, which allows the force generated by the motor to be amplified when it is applied to the compressions straps. Compression straps may have areas of enhanced and/or reduced pressure applied to the leg due to area reduction or increase in portions of the strap for a given force or tension applied to the straps. As the area of the strap increases, the force applied by the strap is dispersed over a larger area, which reduces the pressure applied. Alternatively or in addition, the compression straps can apply enhanced or reduced pressure to the body part by increasing or decreasing the force applied to the compression straps. The compression straps may be tightening and secured using a variety of mechanisms, such as a hook and loop fastener or ratcheting mechanism, for example.

As shown in FIGS. 6A-6J, a variety of closure systems can be used to secure the compression device 600 on the body part, and optionally over a compression stocking 320. For example, the compression straps 618 can be replaced with or used in conjunction with another force transmission component, such as a pad 602 and/or backing component 604, which can conform to a portion of the patient's body part, such as the front, side, or back of the patient's lower leg, for example. The backing component 604 can also include and/or be integrated with a closure system for attaching the device to the body part. For example, as shown in FIG. 6C, the closure system can include a tightening mechanism 606 and a lacing system 608, as described in U.S. Pat. Nos. 6,202,953; 7,954,204; and 8,468,657. In some embodiments, as shown in FIG. 6B, the backing component can be used instead with compression straps 618 using hook and loop fasteners by simply positioning the backing component 604 under the compression straps 618 and securing the compression straps 618 to the backing component 604 using strap guides 620. Fasteners 610, such as clips or buckles or magnetic fasteners for examples, can be used to open and close the closure system around the body part before engaging the tightening mechanism. Sensors, such as pressure sensors, temperature sensors, and accelerometers can be embedded in the backing component.

The pad 602 and backing component 604 can be a molded EVA foam or plastic that fits over the front portion of the lower leg. Use of the pad and backing component may allow the compressive force to be more evenly transmitted to the body part than using discrete compression straps alone, which may improve patient comfort. The backing component can be sized and shaped to cover the portions of the leg that are adjacent or proximate the lace of the closure system in order to ensure that the lace does not transmit force directly against the patient's skin. If compression straps are used, the backing component 604 can include compression strap guides 620, such as loops, for attaching and aligning the backing component with the rest of the device, as shown in FIG. 6B.

Other embodiments can utilize an alternative closure system as shown in FIG. 6C that uses a tightening mechanism 606 to tighten the lace of the lacing system 608. The tightening mechanism 606 can be a rotatable reel with a ratcheting mechanism on which the lace can be wound and unwound. The tightening mechanism 606 can be placed on the backing component 604 with the laces attached to the movable pulleys. A sensor, such as a Hall effect sensor, can be included with the reel to measure the amount of lace that is wound around the reel in order to determine the circumference of the body part, which allows the volume of the body part to be determined, which can be correlated to treatment success and efficacy. The lace can be threaded around a plurality of lace guides that form the closure system. A fastener 610, such as a clasp, latch, buckle, clip, or other fastening mechanism, can be provided to allow the closure system to be opened and closed to make donning/doffing the device easier. As shown, a magnetic clasp can be used to facilitate closure. Although only a single tightening mechanism is shown in FIG. 6C, other embodiments can have a plurality of tightening mechanisms, such as 2, 3, or 4 tightening mechanisms, or one tightening mechanism for each compression zone.

The compression components that include the compression plate, motors, pulley system, controller, battery, and drive cord can also be disposed on a pad 602, which can be made of foam or other comfortable material as described above for the backing component 602. The compression component can be removably attached to the pad which allows the pad to be changed when needed, such as when the pad is soiled or the leg girth changes.

Other closure systems can use different tensioning mechanisms. For example, FIGS. 6A and 6D illustrate an alternative reel based tensioning mechanism 606′, 606″. The reel can be driven by a spring that applies a known and consistent amount of force to the strap, lace, cord, or ribbon that is wound around the wheel and used for securement. The spring can be selected to provide a predetermined amount of baseline compression, such as about 5, 10, 15, 20, 25, or 30 mmHg For each compression zone, a single reel 606′ with two straps 618′ can be used as shown in FIG. 6A, or two reels 606″, each with a single strap 618′, can be used as shown in FIG. 6E.

FIG. 6D illustrates yet another tensioning mechanism 606′″ that is based on ratcheting straps 618″. The straps can have teeth and a rotatable knob or other ratcheting mechanism can travel along the teeth to tighten the straps.

FIG. 6F illustrates another embodiment of a closure system using laces 608′. The laces can be manually tightened by the user by pulling on the ends of the laces. A cinching mechanism 609 can hold the laces in place after tightening or release the laces to loosen the laces.

FIG. 6B illustrates the use of compression straps 618 with hook and loop fasteners. FIG. 6G illustrates that a single motor 660 can be used to drive the pulley based drive train 670 that is used to tighten and loosen all the compression straps 618. A hole or grommet in the compression strap 618 can serve as a movable pulley. FIG. 6H shows compression straps 618 arranged in a parallel configuration, while FIG. 6I illustrates compression straps 618 arranged in an overlapping, crossing configuration with enhanced areas of compression at areas of overlap.

FIG. 6J illustrates an embodiment where the straps 618, drive cord 310, or laces can be integrated into the stockings 650 or sleeve along with pulleys 612, 614 or eyelets to provide a stocking with adjustable compression levels. Pulling the ends of the straps or drive cord tightens the compression stockings.

FIGS. 6K-6N illustrate an example of a magnetic closure system. The backing component 604 can be formed of two sections 601, 603 that can be reversibly attached together and detached from each other using one or more magnetic fasteners 605, each magnetic fastener formed from a female component 607 and a male component 609. The female component 607 can be a receptacle with a magnet for receiving the male component 609, and the male component 609 can be a pin or button made of metal that fits into the receptacle. In some embodiments, the male component 609 can have the magnet and the female component 607 can be made of metal. The receptacle of the female component can be a keyhole receptacle with a undercut with an overhang portion that secures the male component in the female component when under circumferential tension, but that allows the male component to be removed using a force that is applied transversely to the circumferential tension (i.e., force along the axis of the limb). For example as shown in FIG. 6K, one section 601 of the backing component can have three female components 607, and the other section 603 can have 3 male components. When the two sections 601, 603 are brought close together, the magnets and metal portions of the magnetic fasteners automatically draw together to align and lock the two sections together.

FIG. 6O illustrates another example of a magnetic closure mechanism. The backing component can again be formed from two sections 601, 603. At the end of each section can be one or more magnets 620 that draw the two sections together. A locking mechanism 622, such as a bayonet attachment mechanism with a slot and a pin, can secure the two sections together and resist circumferential tension but be removed using a transverse force.

In some embodiments, the foam components, which includes the backing component 604 and the pad 602 attached to the compression plate, can be made from two foam layers, a thin dense foam layer to provide structural integrity and a softer compressible foam layer that faces the skin to provide cushioning and improve comfort. The pad 602 for the compression plate can be made from one or more articulated sections to match the articulations in the compression plate and/or to define zones of compression. Use of multiple sections allows the pad to better conform to the shape of the patient's anatomy and also facilitates sequential compression from multiple zones of compression.

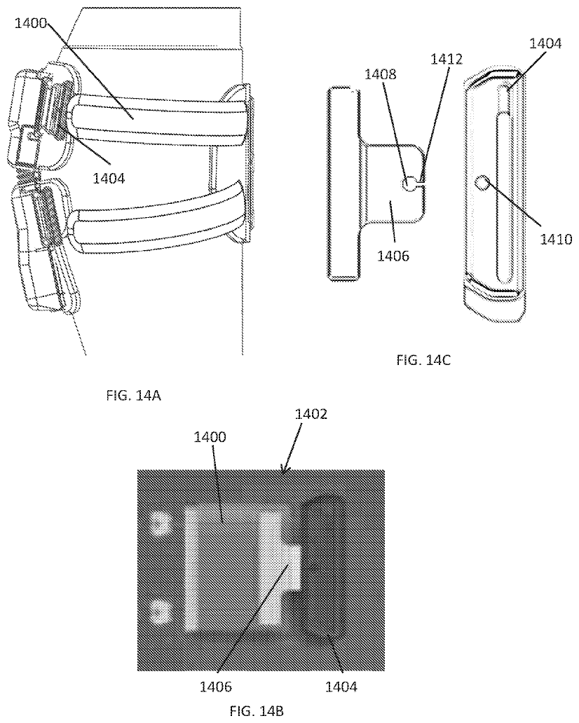

As shown in FIGS. 14A-14C, the compression straps 1400 or cords can include a safety break-away feature 1402 that will break apart when subjected to a predetermined amount of force. For example, the safety break-away feature 1402 can be a D-ring 1404 with a breakable tab 1406, with the strap 1400 attached to the breakable tab 1406. The breakable tab 1406 can have a hole 1408 for receiving a connection pin 1410 from the D-ring 1404 that secures the breakable tab 1406 to the D-ring 1404. The material of the breakable tab 1406 around hole 1408 can be weakened 1412 or constructed to break or fail at about a predetermined pull force, thereby preventing the compression straps from overtightening around the user's limb or body part. In addition to the safety break-away feature, the length of travel of the compression stroke (i.e., the movable pulley lateral travel distance) also limits the amount of compression that can be delivered to the limb.

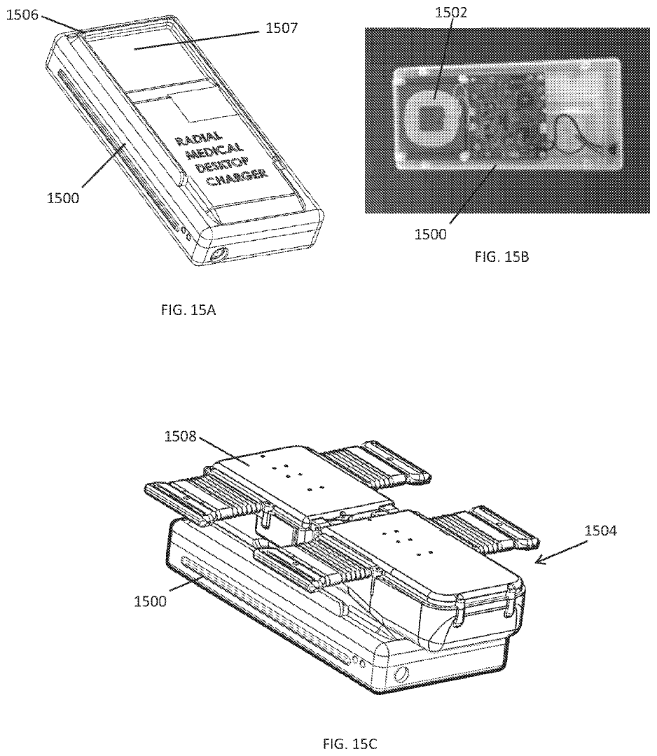

In some embodiments, the compression device can be powered by a rechargeable battery that can be charged using a port in the housing and an electrical cable. In another embodiment as shown in FIGS. 15A-15C, the rechargeable battery can be charged inductively using an alternating electromagnetic field. An inductive charging plate 1500 with an induction coil 1502 can create an alternating magnetic field that can generate current in an induction coil within the compression device 1504 that can be used to charge the rechargeable battery. The inductive charging plate 1500 can have alignment markings or features, such ridges 1506 and/or a recess 1507, that matches the form factor (i.e., the size and shape) of a portion of the housing 1508 for the electronics of the compression device 1504 that facilitate the alignment and proper positioning of the compression device 1504 on the inductive charging plate 1500.

In some embodiments, the inductive charger can charge the rechargeable battery in the compression device in about 30 to 120 minutes (i.e., about 30, 60, 90, or 120 minutes), and from a full charge, the compression device can have at least about 4, 8, 12, or 24 hours of active run time.

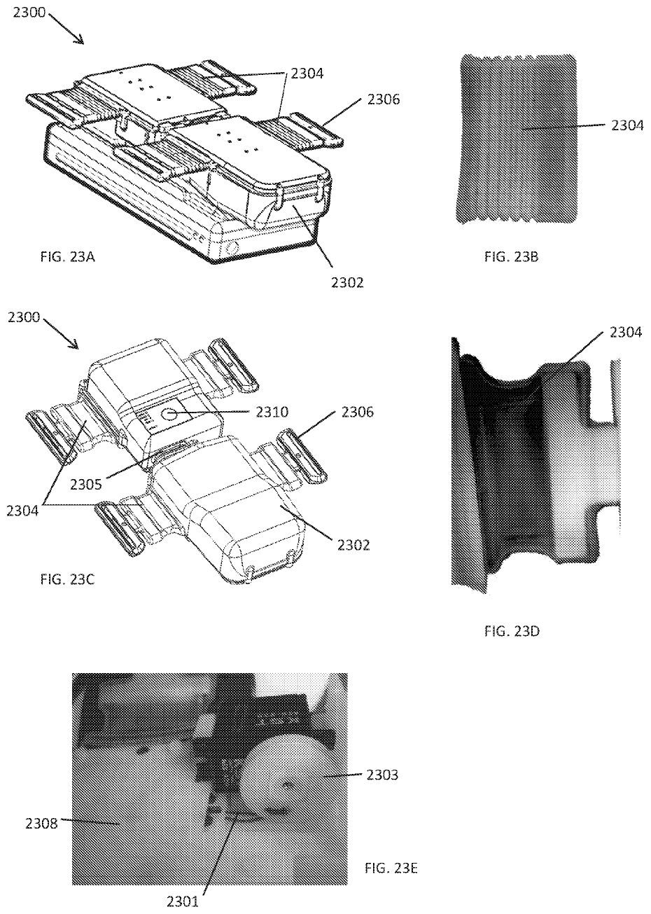

In some embodiments as shown in FIGS. 23A-23E, the compression device 2300 has a housing 2302 that has a feature that provides water resistance and slack management of the drive cord, which reduces the likelihood of entanglement of the drive cord or disengagement of the drive cord from the pulleys. The housing 2302 can have a boot enclosure 2304 that encloses the portions of the drive train (e.g., the drive cord as shown in FIG. 14B) that exit the main housing enclosure. The boot enclosure 2304 provides a spring action to take up slack from the drive cord and also prevents water from getting into the electrical components within the housing.

As shown in FIGS. 23A and 23B, the boot enclosure 2304 can be corrugated to provide the requisite spring action and to accommodate changes in length of the drive train during compression cycles. Alternatively, as shown in FIGS. 23C and 23D, the boot enclosure 2304 can be non-corrugated but is elastic so that it can stretch and shrink and take up slack during compression cycles. In some embodiments, the boot enclosure is made of silicone, particularly the non-corrugated boot enclosures. In other embodiments, the boot enclosures can be made of plastic, rubber, or other flexible and/or elastic materials. The boot enclosure 2304 can be integrated into the breakable tab and ring feature 2306 described above.

In some embodiments, the mechanical pulley based drivetrain is separated and/or isolated from the electrical components with a cover or divider 2308 as shown in FIG. 23E. FIG. 23E also illustrates the drive cord 2301 around the drive pulley 2303 where the slack has been taken up by the boot enclosures. In some embodiments, the boot enclosure surrounds the drive train components that exit the housing and prevents water or other liquids from entering the housing through those exits.

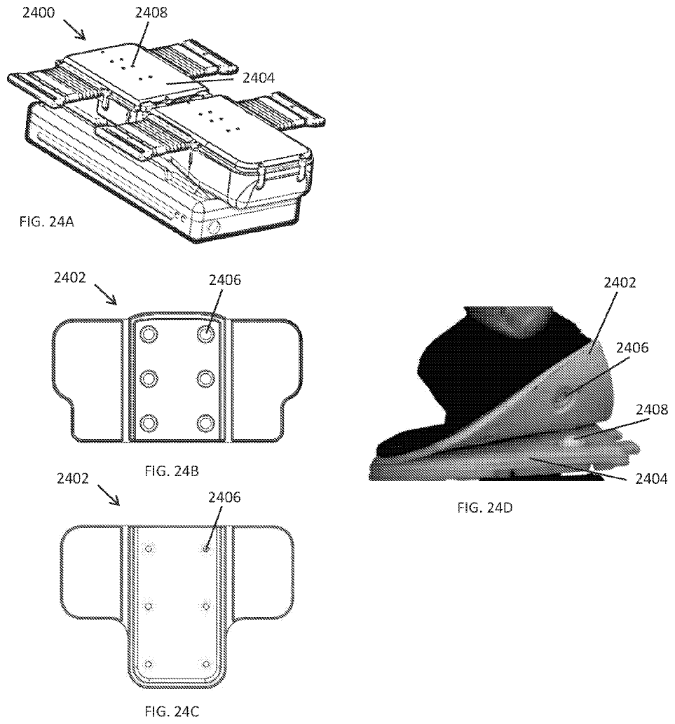

FIGS. 24A-24D illustrate one way that the foam padding 2402 can be attached to the compression plate 2404 that forms a portion of the housing of the compression device 2400. In some embodiments, a mechanical attachment mechanism is used to attach the foam padding 2402 to the compression plate 2404. Use of adhesives tends to work poorly because it allows the pad to slide slowly over time, which eventually results in the pad being positioned poorly over the compression plate. In contrast, a mechanical attachment mechanism can provide a secure and stable fixation of the padding 2402 to the compression plate 2404. In some embodiments, the mechanical attachment mechanism is a button type attachment with a female socket 2406 and a male stud 2408 that can be simply pressed together. In some embodiments, the padding 2402 can have the female sockets 2406 and the compression plate 2404 can have the male studs 2408, while in other embodiments the padding can have the male studs and the compression plate 2404 can have the female sockets. As shown, the padding 2402 can have a base portion 2410 that attaches to the compression plate 2404 and a pair of wings 2412 that can articulate to better conform to the body part to which it is secured.

As shown in FIG. 24A, the compression plate 2404 can be formed in two portions that can be joined together with a hinge. To allow the two sections of the compression plate to move relative to one another, the housing 2302 can be formed into two parts as shown in FIG. 23C, with a separate housing over each section of the compression plate. In some embodiments, the drive train components are wholly contained in each of the two housings, while in other embodiments, the drive train may extend across both housings. A boot enclosure 2305 can be used to join the two housings together in a flexible manner and allow the passage of the drive train or other components between the housings while providing a water resistant barrier.

Although the descriptions herein generally discuss the use of compression straps, any of the closure systems described herein can be used instead.

In some embodiments, active feedback is provided via wearable sensor(s) (e.g., pressure, force and/or strain sensors) and a feedback system to index the pressure or tension applied by the compression straps and/or compression plate to a prescribed baseline condition or value. For example, the motor can be driven to rotate the drive pulley until a sensor in line with the drive cord reads a desired strain, or a sensor against the patient's skin or against the compression stocking measures a desired pressure, or a sensor measures that the motor draws a predetermined or a set current which can be correlated to a load on the motor, which can be correlated to strain.

Sensors can be integrated into the stocking, the backing component (e.g., the foam cuff), compression straps, the drive cord, the lace(s) for fastening mechanism, the tensioning reel of the fastening mechanism, the motor, and/or the force/pressure transmission components. Other sensors may be externally mounted onto the device, such as a pressure sensor disposed on a skin facing side of the compression plate, compression strap, or understocking, for example. These sensors may also provide feedback to the compression device and may communicate wirelessly or through a wired connection.

The system may be capable of providing user/patient feedback prior to active compression engagement to ensure that baseline conditions are achieved before beginning active compression therapy. For example, the system may be capable of verbally (e.g., in plain spoken language of recorded caregiver), auditory (beeps or other), or visually (on-board display, smartphone or remote control) providing a cue to engage the user/patient to reset device to baseline conditions. User feedback (e.g., auditory, visual, tactile) can be provided to the user when baseline compression level is achieved. In addition, user feedback (e.g., auditory, visual, tactile) can be provided to notify the user/patient that baseline compression level has not yet been reached.

In some embodiments, the drive pulley rotation is engaged for specific time interval, number of rotations, and/or power output (e.g. input drive function), per prescribed parameters, which may be predetermined or selected at the beginning or during treatment. In addition or alternatively, the input drive functions can be modulated by sensor measurements (e.g., stain gauge, accelerometer), in order to deliver a precise and consistent amount of compression to the user/patient. For example, an integrated strain gauge, pressure sensor, and/or force sensor can be provided to provide real time feedback of compression level in the mechanical compression system so that the system can provide a predetermined, set, or desired level of compression, such as light compression less than 20 mmHg of pressure, moderate compression between 20 to 40 mmHg, strong compression between 40 and 60 mmHg or very strong compression over 60 mmHg The pressure sensor, force sensor, or strain gauge can be positioned against the skin or against the stocking and under the base plate, compression straps, compression mechanism, pads, and/or backing to measure the interface pressure, which is the actual pressure applied to the body part, in contrast to an inflatable compression device that may only report the inflation pressure.

Integrated strain gauge plethysmography on the wearable treatment system can be used to adjust therapy system with real time feedback. The sensors can be placed on a skin facing surface, such as the back of the compression plate as shown in FIG. 3C, to directly measure the pressure and/or force applied to the body part. Alternatively or additionally, these sensors can be placed on the skin facing side of the backing component and/or integrated into the stockings. Alternatively or in addition, the sensors can be positioned and placed to measure the tension in the drive cord, which may indirectly indicate the amount of compression applied to the body part. The compression to the body part is generated by creating tension in the drive cord using the motor. The tension generated in the drive cord can be transmitted and amplified by use of a pulley system(s) to drive compression straps. The pulley system can include a mixture of fixed pulleys that are attached to the compression plate as well as moveable pulleys attached to the compression straps (or laces, cords, etc. that are used for fastening the device on the body part). The pulley system may create a mechanical advantage or variable mechanical advantage per zone (e.g. by increasing or decreasing the number of pulleys attached to the compression strap or by using different gear ratios) to enhance sequential compression. The compression system may take up slack initially from a lower zone or more distal zone that is nearer the motor and drive pulley, thereby compressing the lower zones first, then sequentially compressing zones in an upward direction as slack is taken up. Sequential compression may also be enhanced by passive (friction) or active (multiple servos/motors/zones) means, and/or multiple drive pulleys (with different diameters) with clutching mechanism. Modulation of the applied compression treatment can be based upon active, real time feedback from various system sensors and/or measurements (e.g. strain gauge, pressure sensor, force sensor, heart rate sensor, blood pressure sensor, impedance sensor, clot formation detection, blood flow measurements, ultrasound sensor, wound size measurement, temperature sensor, gas sensor, blood chemistry, posture sensor, accelerometer, etc.) independent of user input. Modulation of the compression based on sensor feedback creates a smart/artificial intelligent system that can learn, adjust, and optimize treatment. For example, an integrated accelerometer on the wearable compression treatment system can be used to modulate treatment in accordance with the treatment appendage condition, such as modulating treatment based on posture and/or activity. In some embodiments, user inputs can also be entered into the system. Modulation of the compression treatment can also be based upon active, real time feedback from external data (e.g. patient weight, temperature, ambulation, cognitive, heart condition, drug reaction, database of historic treatments, analysis of user input(s)) that can be retrieved by the system through a wireless or wired connection or input into the system by the user/patient. For example, the compression delivered by the device can be synchronized with the patient's heart rate, such as delivering a compression for every predetermined or set number of heart beats, such as every 1 to 30 heart beats. The number of heart beats can be selected based on the time needed for refilling the venous vessels with blood. Synchronization with the heart rate can be particularly useful to treat peripheral arterial disease by assisting the heart pump blood to the extremities. Real time and/or historic compression achieved, including magnitude, duration, and frequency of compression, can be recorded for one or more compression zones using strain gauges, pressure sensors, force sensors, and the like, and/or calibrated current draw from the motor which can be related to and/or serve as a proxy for compression level. Any of the other parameters measured by the sensors can also be recorded in real time and/or in a historic fashion. The user/patient and/or caregiver/physician may remotely initiate, control, monitor and/or modulate treatment on the wearable treatment system using, for example, an application on a smartphone, tablet or other computing device.

The drive cord may be spooled and unspooled around a drive pulley that is fixed to the drive shaft of the motor. As the motor rotates the drive shaft and drive pulley, the spooling or unspooling of the drive cord generates or releases tension in the drive cord that is translated to individual or multiple compression straps through a pulley system that includes fixed pulleys attached to the compression plate and movable pulleys attached to the compression straps. The pulley system can provide a mechanical advantage greater or less than 1:1 depending on the pulley configuration used. For example, attaching two movable pulleys to a compression strap will generally increase the mechanical advantage to greater than 1:1, so long as the drive cord generating the force on the compression strap is oriented generally parallel to the direction of the generated force, while reducing the amount of travel of the moveable pulleys attached to the compression strap.

In addition, gearing can be used to obtain greater or less than a 1:1 gear ratio from the output of the drive motor, which also allows for the generation of mechanical advantage to increase the compressive force that can be achieved with a given motor.

In order the reduce tangle of the drive cord around the drive pulley, rotation and spooling of the drive cord around the drive pulley can be limited to about 360 degrees or less (i.e., about one rotation or less) of the drive pulley. The size and circumference of the drive pulley therefore can determine the amount of travel or spooling of the drive cord, which along with the pulley system configuration, determines the amount of compression applied by the compression straps. The size of the pulley can be chosen to have the smallest circumference that provides the desired amount of drive cord travel to generate the desired amount of compression. This would result in the smallest tangle free drive pulley, which allows the system to have a reduced, slimmer, more compact form factor. In some embodiments, the drive cord never crosses itself, meaning the drive cord is not wound around itself around a pulley (such as by limiting the spooling to less than 360 degrees) and the path the drive cord takes never crosses itself. This reduces tangling and wear from friction that would occur if the drive cord rubbed against itself.

The use of cams, different pulley sizes, different numbers of pulleys, allows for variation of mechanical advantage in specific zones, or remote adjustment of zone (e.g., use greater mechanical advantage, longer travel, drive cord with less elasticity to deliver more compression to lower leg zones). For example, the use of a cam allows the mechanical advantage to be varied during a compression cycle to better approximate native muscle contraction and/or to alter compression dynamics. One or more movable pulleys can be attached to each end of the compression strap in order to equalize and/or balance the forces applied to the compression strap. If a movable pulley is attached to only one end of the compression strap while the other end of the compression strap is, for example, fixed in place, then the generated force may tend to torque and twist the leg, which may be uncomfortable to the user, in addition to creating the desired compressive force. By balancing the forces with pulleys attached to both ends, the torqueing and twisting force is eliminated or reduced while still providing the compressive force. Similarly, a pulley based attachment system, as shown in FIG. 6F for example, also balances the forces applied when fastening the device to the body part, and therefore provide similar advantages. Therefore, it would be advantageous for the system and method to provide balanced tensioning of the compression straps by having both ends of each compression strap pulled equally from both ends with the pulley system to balance the force applied. Spooling the drive cord creates tension and force in the drive cord that can be transmitted to the compression straps using the pulley based tensioning system. The drive cord and other compression system elements, such as the compression strap, can be integrated partially or fully in the understocking by, for example, integrating these elements into the weave/knit of the understocking. Portions of the pulley system(s), such as the fixed pulleys, can be partially or fully attached to the compression plate and/or injection molded into the compression plate such that the pulleys are embedded within the compression plate, or woven directly into the weave of the understocking. The compression plate can be woven directly into the understocking or injection molded directly onto the understocking or can be fastened on top of the understocking. The compression strap orientation, overlapping areas of compression straps, the pattern of the compression straps on the body part (e.g., parallel, criss-cross, wider straps to narrower straps), and/or construction of the compression straps (e.g., size, width, thickness, elasticity) can be modified to achieve unique and/or desired compression waves and characteristics (e.g. straps have more area or more efficiently compress in zones of maximum compression, overlapping or oblique strap configurations used to gain cumulative compression or reduced compression in zones, respectively.) The compression straps can be used with a pad or shell, which can be made of foam, plastic and other materials, in order to more evenly distribute the compressive forces to the body part. In some embodiments, the pad or shell can be integrated into stockings. The pad or shell can be sized to fit the body part, and may be custom sized based on measurements of the size and/or shape of the body part. A higher density of force transmission elements (e.g. compression straps) may be used in areas where higher compression is desired. The compression straps may have inflatable zones or be entirely inflatable to pad the straps and/or may be constructed fully or partially of an inelastic material in order to efficiently transmit the compressive forces to the body part. The compression straps may have interwoven and/or integrated electronics that communicate via wire or wirelessly to a control unit. The compression straps may be constructed from knit, woven, electrospun, sheet, and/or extrusion materials or composite of textiles or non-textiles (microdenier). For example, the compression straps may be made from EVA foam or a plastic covered with a textile.

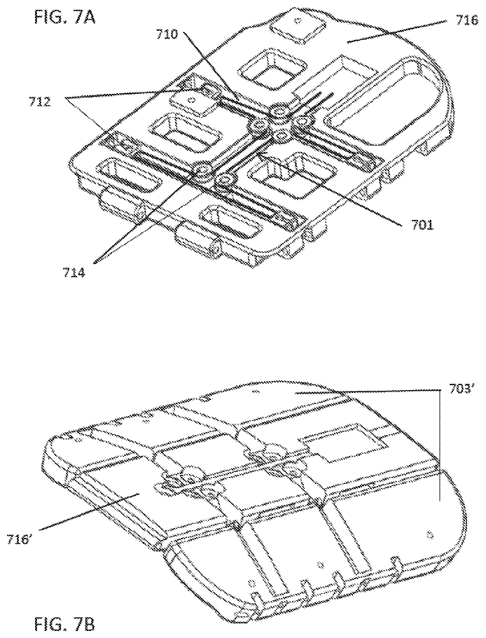

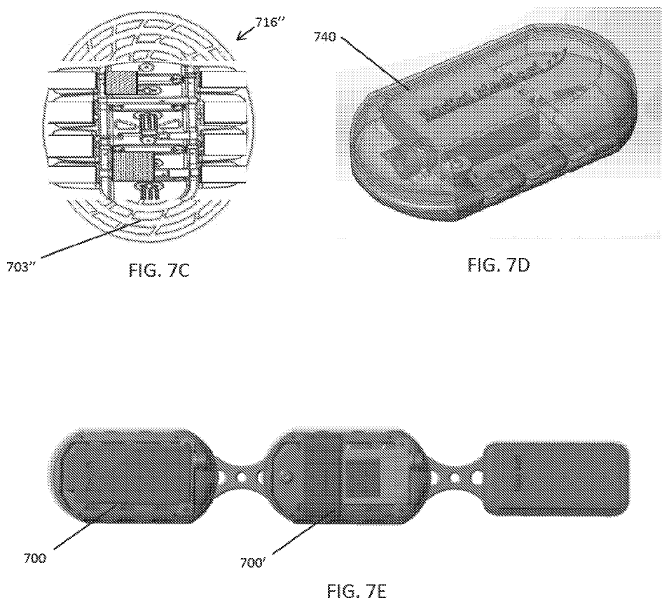

As shown in FIGS. 3A-3C and 7A-7E, the system and method may include a rigid or semi-rigid compression plate 316, 716, 716′, 716″ that is pulled into the appendage or body part, such as the lower leg, and released via an attached drive train mechanism, locally compressing the area under the compression plate. The compression plate facilitates and allows selective pressure to be applied to specific vascular, muscular or lymph regions. The compression plate is pulled into a specific anatomical area in a balanced condition (i.e. substantially without torque as described herein) due to both ends of the compression strap being attached to movable equalizing pulleys and connected to the same drive cord, which ensures that equal force is applied to both ends of the compression strap. The compression plate may be fabricated with one or more zones that may be shaped with different areas in different zones to achieve a specific compression paradigm for each zone. Because pressure=force/area, either or both force and area to which force is applied could be varied per zone or per condition. For example, making one zone of the compression plate smaller than another zone while subjecting the zones to the same force, results in a higher pressure being exerted by the smaller zone. Alternatively or additionally, each zone of the compression plate can be associated with its own compression strap, which may be subjected to different forces due to having an independent motor and pulley system, or by varying the pulley configuration to modulate the travel distance of the movable pulleys and/or the number of pulleys attaches to the compression strap, for example. In addition, both area and force could be modified with areas of compression plate that telescope or collapse or expand (e.g. wings retract into the compression plate body partially or fully). The compression plate may be constructed from plastics, metals, carbon fiber, ceramics, wood or combinations thereof. The compression plate may be “3-d printed” independently or directly onto understocking using the method of additive manufacturing. The compression plate may be removable from the understocking such that the understocking, which contacts the skin, could be disposed or washed/cleaned. The compression plate may have a sealed cover to allow the unit to prevent fluid entry into electromechanical system. The compression plate may have compartments to hold electronics and a selectively removable rechargeable battery pack, which may be recharged during the release stroke of the system by, for example, attaching the drive cord to an alternator.

The compression plate 316 shown in FIGS. 3A-3C has the fixed pulleys 314 attached to the top surface of the compression plate 316 and the movable pulleys 312 can be positioned against the top surface or above or within cutouts in the compression plate 316 to reduce friction on the movable pulleys 312. Alternatively, as shown in FIG. 7A, the fixed pulleys 714 and movable pulleys 712 can be disposed within recessed channels 701 that are embedded within the compression plate 716, allowing the device to have a slimmer form factor. In addition, the fixed pulleys 714 and movable pulleys 712 can be aligned so that the drive cord 710 between the fixed pulley 714 and movable pulley 712 is aligned with the direction of movement of the movable pulley 712, thereby maximizing the compressive force delivered by the device. This alignment of the fixed pulleys and movable pulleys can be achieved in any of the compression plates.

FIG. 7B illustrates yet another embodiment of the compression plate 716′ with articulating side wings 703′ that allow the compression plate 716′ to better conform to the patient's body part. In some embodiments, the compression plate may be curved, or at least the skin facing surface can be curved, to better fit the patient's body part. In some embodiments, the entire compression plate can curved or just the side wings can be curved. FIGS. 7C illustrates an embodiment of a compression plate 716″ that is curved. As shown in FIG. 7C, the compression plate 716″ can be curved with optionally two hinged or articulating side wings 703″ that allow the compression plate 716″ to conform to a joint, such as a knee or elbow or shoulder, for example. The compression plate 716″ can be circular as in FIG. 7C, but other shapes can also be used, such as oblong, elliptical, or oval. These devices can be sized and shaped to provide compression to the joint and/or to the portion of the body above and/or below the joint, with each portion of the body optionally forming a discrete compression zone.

A cover 740, as shown in FIG. 7D, can be attached to the compression plate over the components such as the motor, electronics, battery, and pulleys.

FIG. 7E illustrates a modular system with two compression devices 700, 700′ that can communicate with each other to deliver coordinated compression therapy, as further described herein. The compression devices may be attached independently of each other, or may be physically attached as shown through various linkages, such as an extended compression plate.

Active feedback from strain gauges can be used to evaluate efficacy of treatment and adjust treatment independent of user input for compression therapy system. The compression system may be capable of providing a compression cycle frequency of greater than 1 Hz, although in some embodiments, the system is also capable of providing a much lower cycle frequency, so as 1 compression and release about every 1 to 60 seconds, or about every 5, 10, 15, 20, 25, or 30 seconds, in order for blood to refill the veins between compressions. The ability to deliver compression cycles of less than 1 minute with a portable device has not been achieved using traditional pneumatic devices. The speed of compression allows the system and method to achieve native or healthy flow rates, volumes, and flow dynamics curves, and can be tailored to match the needs of each patient and disease state. The speed and timing of the compressions of the individual compression zones allows the system to generate specific venous, arterial, or lymphatic flow waveforms that cannot be achieved using an inflatable cuff. The compression system may be capable of generating compressive forces greater than about 60 mmHg and in some embodiments, in excess of 200 mmHg. In some embodiments, the compression system may be capable of generating compressive forces between about 0 and 60, 70, 80, 90, 100, 110, 120, 130, 140, 150, 160, 170, 180, 190, or 200 mmHg The compression system may be capable of providing a circumferential stroke length of greater than about 0.5 in per compression zone, or greater than about 0.1, 0.2, 0.3, 0.4, 0.5, 0.6, 0.7, 0.8, 0.9, or 1.0 inch per compression zone. The circumferential stroke length is the reduction in circumference of the system, i.e. the compression straps and compression plate wrapped around the body part, and body part during a compression cycle. In some embodiments, the compression system is capable of delivering zone specific treatment, meaning each compression zone can independently deliver a prescribed amount of compression at a prescribed cycle frequency.

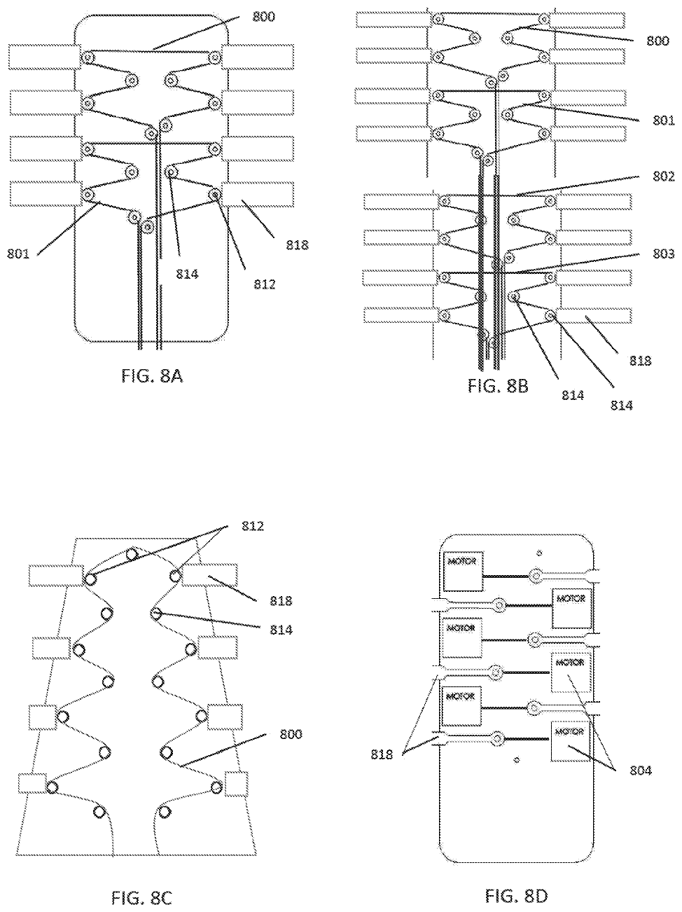

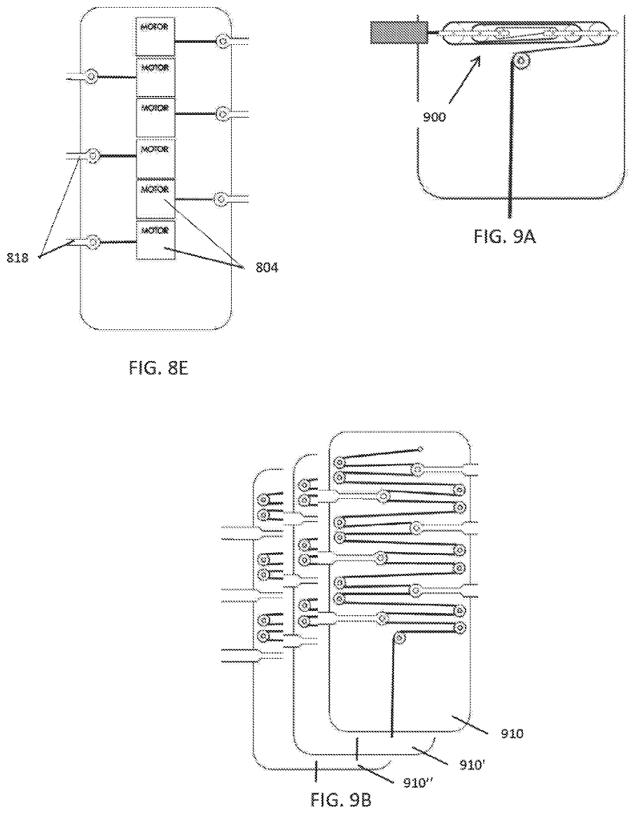

The compression zones can be generated using a variety of techniques. For example, FIG. 3A illustrates a device that provides two zones of compression using two motors, each motor driving compression for its zone. FIGS. 8A-8C illustrate alternative embodiments having multiple zones driven by a single motor. As described herein, the motor can drive a pulley based drive train having movable pulleys 812, fixed pulleys 814, and compression straps 818 attached to the movable pulleys 812. For example, FIG. 8A illustrates a two zone device that is achieved, for example, using a single motor that drives two drive pulleys on its driveshaft, with each drive pulley attached to its own drive cord 800, 801. Similarly, FIG. 8B illustrates a four zone device with a motor that drives 4 drive pulleys each with its own drive cord 800, 801, 802, 803. The drive pulleys can be sized differently to provide different levels of line travel per rotation, which results in a different level of compression in each zone. Any number of zones can be created simply by adding additional drive pulleys to the driveshaft of the motor. FIG. 8C illustrates an embodiment that provides coordinated compression using a single motor and a single drive pulley and a single drive cord 800. In this embodiment, the distance between the movable pulley 812 pairs can be varied to limit the amount of compression delivered to each zone. As shown, there are 4 zones each with a different distance between the movable pulley pairs, resulting in 4 different zones of compression.

FIGS. 8D and 8E illustrate the use of multiple motors 804 to create multiple zones of compression. Each compression strap 818 or equivalent can be driven by one or two motors (e.g. one motor attached to each end of the compression strap). As shown, the motors 804 can be placed on the outer edges of the compression plate. Alternatively, FIG. 8E illustrates motors 804 being placed in the middle of the compression plate.

As shown in FIG. 7E, the compression systems and devices and methods described herein may be used in a modular and interconnected fashion. The individual units can optionally include mechanical and/or electrical linkages and/or interconnects that allow multiple units to be physically and electrically connected to each other. For example, magnetic fasteners or other fasteners, tabs and interlocks can be used to connect adjacent devices together. Wireless or wired communications can be included to allow synchronization of therapy between all the interconnected units. Wireless communications allows multiple devices to work together even if the devices are not connected together physically or electrically. Synchronization of the units can involve adjusting the magnitude, the frequency, the duration, and other compression parameters of the multiple units to achieve a desired fluid flow and/or compression pattern.

For example, a unit placed on the lower leg may deliver a compression to the lower leg, and then a unit on the upper leg can deliver a compression to the upper leg after a set delay in order to drive blood through the venous vasculature. These modular features allow a set of smaller devices to be combined into a larger device that can still provide coordinated compression between each of the compression zones in the combined system. In addition, the units can have different sizes to fit the different body parts, such as the lower leg, the upper leg, the lower arm, the upper arm, the hand, the fingers, and the torso, for example. The units can come in multiple predetermined or customized sizes that fit various ranges of body part circumferences, such as extra small, small, medium, large, and extra-large. Although the units may be synchronized, the one or more units may be operated independently and be operated at its own compression level and frequency.

FIG. 9A illustrates the mechanical advantage that can be generated by a pulley based drive train 900 to amplify the force generated by the motor, therefore allowing the use of a small, inexpensive motor to generate large compressive forces. Multiple pulleys and/or multiple windings per pulley can be used to increase the mechanical advantage.

FIG. 9B illustrates a multi-layered device, with each layer 910, 910′, 910″ including a pulley based drive train. The layers can be sandwiched together or layered on top of each other to create a device with increased mechanical advantage while using smaller and thinner components.

FIG. 10A illustrates that pulley travel distance can be increased for a given travel zone by positioning the fixed pulleys 1014 at the outer edges of the travel zone while the movable pulleys 1012 can be moved to and away from the fixed pulleys. FIGS. 10B and 10C illustrate that the compression device 1000 can be attached to the compression stocking 1020 using various optional attachment mechanisms that can be used in addition to alignment markings or features on the stocking. For example,

FIG. 10B illustrates that a compression device 1000 can be attached to a compression stocking 1020 using snap fittings 1030, while FIG. 10C illustrates the use of a magnetic coupling mechanism 1040.

### Connected Health, Precision Medicine, Smart Medicine

The compression systems and methods described herein include gathering position data (e.g., compression strap/pad position, patient position—standing or laying down or sitting, device position), pressure/compression data, temperature data and/or other relevant parameters and data from the sensors of the mobile/wearable compression therapy system. The data may be transmitted wirelessly or through a wired connection to a smart phone, smart watch, tablet, laptop computer, desktop computer, other computing device or other receiving device. FIG. 11 illustrates an embodiment of a remote device, such as a smart phone 1100, with a user interface 1102 that can be used to display treatment related data, to control operation of the compression device, and communicate with a server and/or cloud computing network and/or database. In some embodiments, compression therapy treatment can be controlled remotely using the smart phone, smart watch, or other remote device. In some embodiments, the user interface is a graphical user interface (GUI) including a user interface with any of a variety of user interaction modes such as user inputs from touch, voice, movement, user position or orientation, user activity, user location and the like inputs that provide the context and environment where the user is receiving therapy or using the device. In some aspects, the user input is provided directly by affirmative user action such as use of a touch screen, key pad or other action or by indirect or inferred user action such as in a sensor output like an accelerometer or GPS sensor or other data collection provided by a device associated with the user.

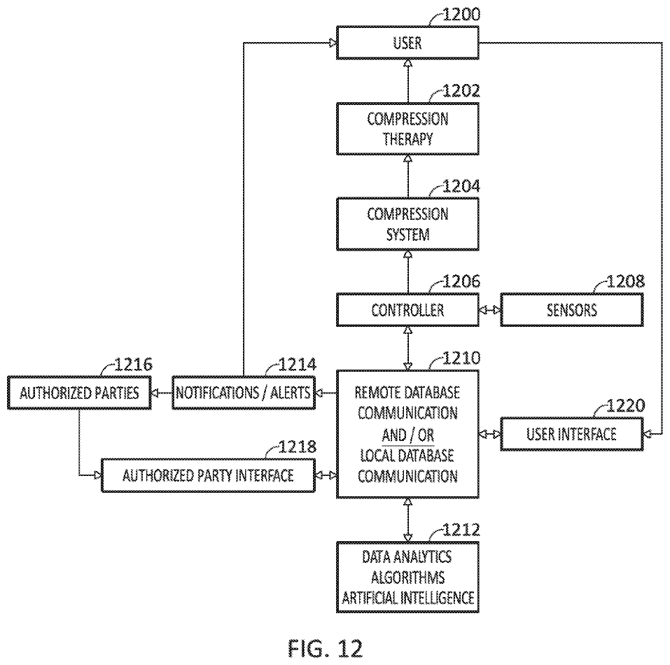

FIG. 12 is a flow chart that illustrates the communication, flow of information and data, and/or connections between the various components of the system for some embodiments of the invention. For example, the user 1200 receives compression therapy 1202 from the compression system 1204. A controller 1206 of the compression system controls its operation by, for example, controlling the operation of the motors that generate compression. The controller 1206 can request and receive data from sensors 1208 and use the sensor data as feedback to modulate the compression therapy 1202 delivered by the compression system 1204. The sensor data, treatment data, device operation data, compliance data, and other data can be recorded in on-board memory in a local database and/or sent to a remote database 1210 for local data analysis and/or remote analysis using data analytics, various algorithms such as machine learning algorithms, and/or artificial intelligence algorithms 1212. Once the data is processed locally and/or remotely, the treatment and compression parameters may be modulated as further described herein. The modulated parameters can be sent to the controller 1206 and compression system 1204 to deliver modulated compression therapy to the user. Notifications and/or alerts 1214 can be sent to the user 1200 and/or authorized parties 1216 by the local compression device, a smart phone, or by a remote device or system, such as a server or cloud computing network. Authorized parties 1216 may also obtain access to the local data and/or remote data through an authorized party interface 1218, such as web portal or application on a computer or smart phone, while the user can access the local data and/or remote data through a user interface 1220 that can be an application on a smart phone or computer, a web portal, or on the compression device itself.

FIG. 29A shows examples of screens that can be viewed using the app or program. A compliance data section 2902 represented in graphical form 2904 showing both the actual and prescribed usage time. A photo section 2904 can be used to view or upload patient photos. A survey results section 2906 allows for manual entry of subjective feedback on qualities such as pain. As shown in FIG. 29B, a notes section 2908 allows for entry and viewing of notes. The main screen can show the most recent note and can be navigable to historical notes and to entry of a new note. A prescription section 2910 can allow for entry and viewing of prescriptions, including compression level, duration, length of treatment, and days remaining for treatment. The main screen can show the current prescription and is navigable to historical prescriptions and updating prescriptions. The system can be configured to only allow editing and entry of prescription information by an authorized user (e.g., a clinician). A raw sensor data section 2912 allows for viewing data and functionality of the onboard sensors. In some embodiments, as shown in FIG. 29B, the main screen lists the sensors and shows the functionality status, and is navigable to the actual data from each sensor.

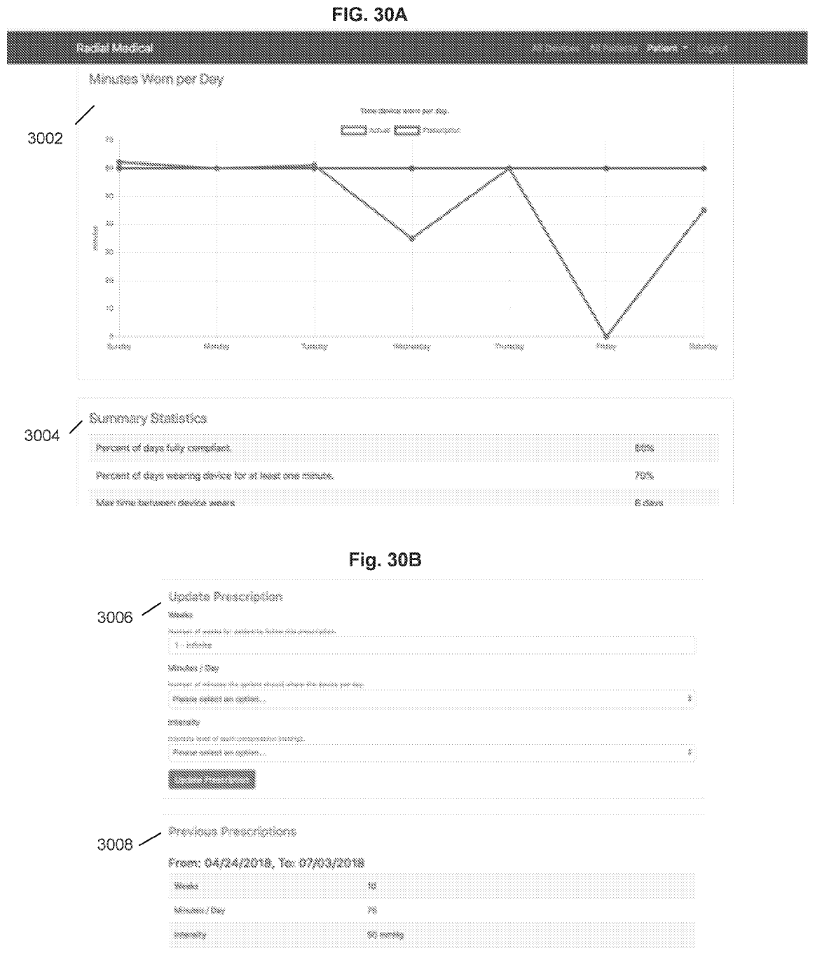

FIG. 30A shows an example of a screen viewable by a clinician monitoring a patient(s) using a compression device as described herein. When viewing data relating to an individual patient, the clinician can view compliance information in graphical form 3002 and a summary of statistics 3004 showing compliance information. FIG. 30B shows a prescription screen or interface 3006 a clinician can use to update a patient prescription by inputting a prescribed treatment duration, treatment time and treatment intensities. The clinician can also access previous prescription history 3008.

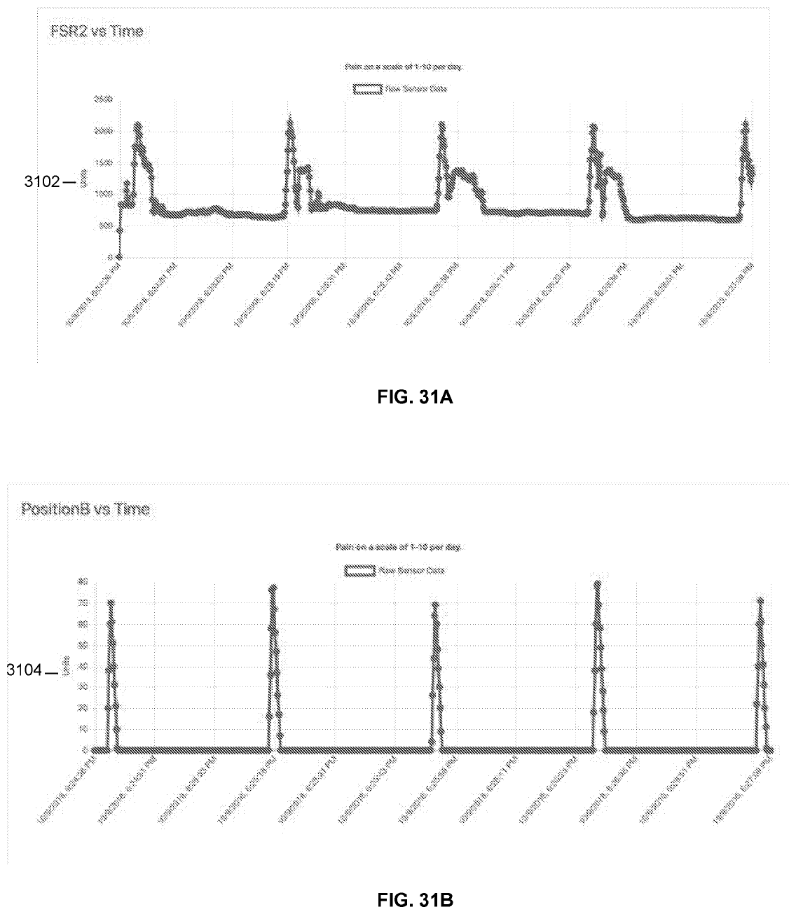

FIGS. 31A and 31B provide examples of raw data streams that can be accessed using the app or program. FIG. 31A shows data from a force sensor over time in graphical form 3102. FIG. 31B shows data 3104 from a position sensor or accelerometer over time. The change in position lines up with the spike in force corresponding to applied compression.

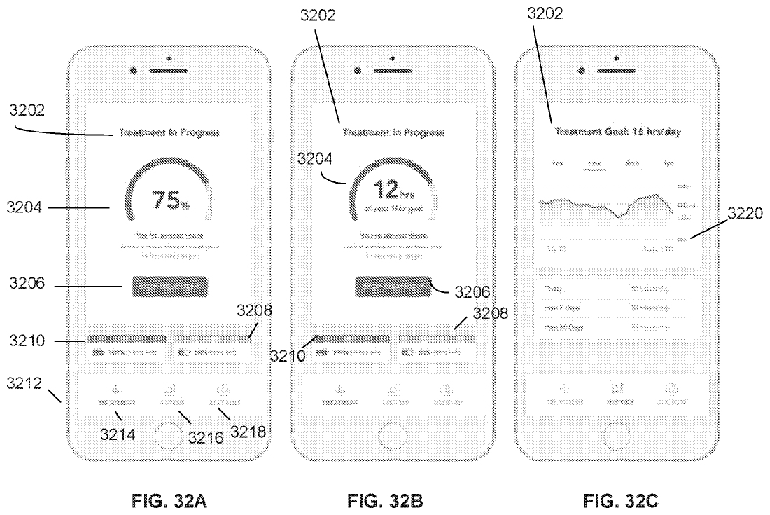

FIGS. 32A-C provide additional examples of views from an app or program that can be used with the compression devices described herein. FIGS. 32A and 32B show a screen representing a treatment in progress indicated by the status 3202 at the top of the screen. A treatment progress indicator 3204 below the text status. In FIG. 32A, the progress is represented as a percentage. In FIG. 32B, the progress is represented as an amount of time. The user can select which progress view they prefer. The app or program can also show the patient or user how much additional therapy they must perform to meet their goal, and provide encouragement to reach the goal. The screen provides a ‘stop treatment’ control 3206 that allows a user to stop treatment. The screen can show the progress for each device (e.g., right 3208, left 3210). At the bottom of the screen is a menu 3212, showing a ‘treatment’ section 3214, which is currently being shown in FIGS. 32A and B, a ‘history’ section 3216, and an ‘account’ section 3218. FIG. 32C shows an example screen in the ‘history’ section. The screen can display historical data 3220 on patient progress vs. patient goals.

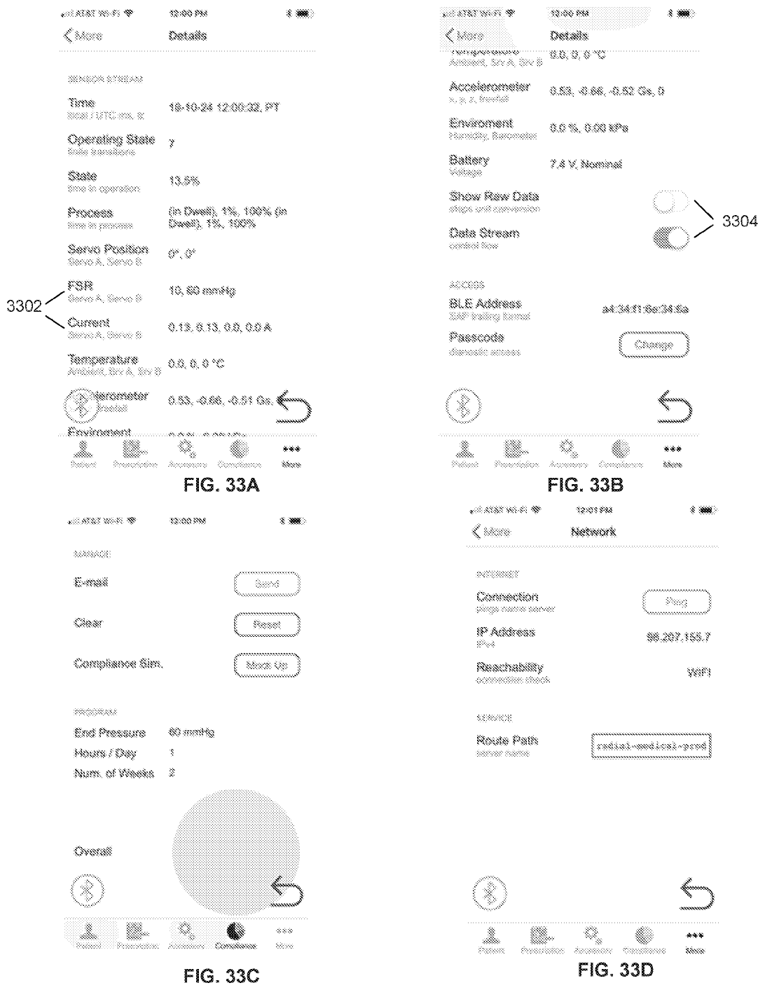

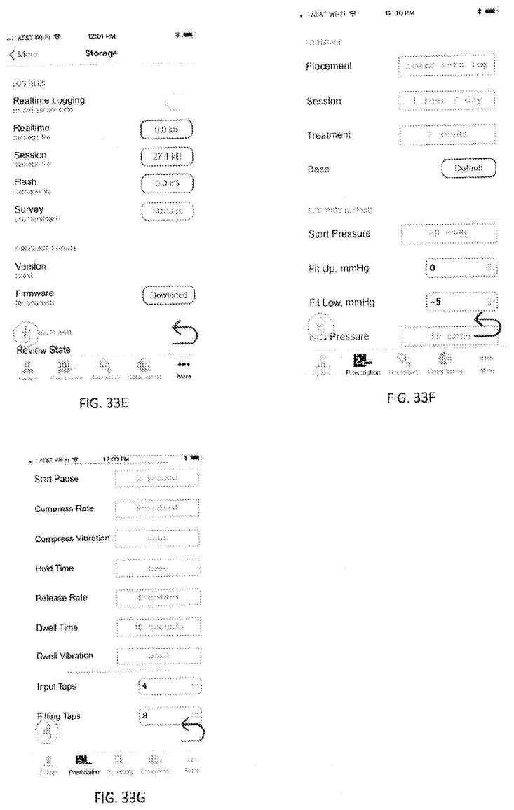

FIGS. 33A-D show various example screens from the app or program. FIGS. 33A and B show an example screen showing a view of raw data streams 3302 from sensors on the compression device including position sensor, force sensor, current, temperature, accelerometer, environment, battery information. FIG. 33B also provides controls 3304 for showing raw data and the data stream. FIG. 33C shows an example compliance screen and provides the ability to send the compliance information, clear the information, and compliance sim?. FIG. 33D shows an example screen displaying network settings. FIG. 33E shows an example screen displaying storage settings. FIGS. 33F and G display example screens showing prescription and allowing updating of prescription (e.g., with proper authorization). FIG. 33G shows an example screen

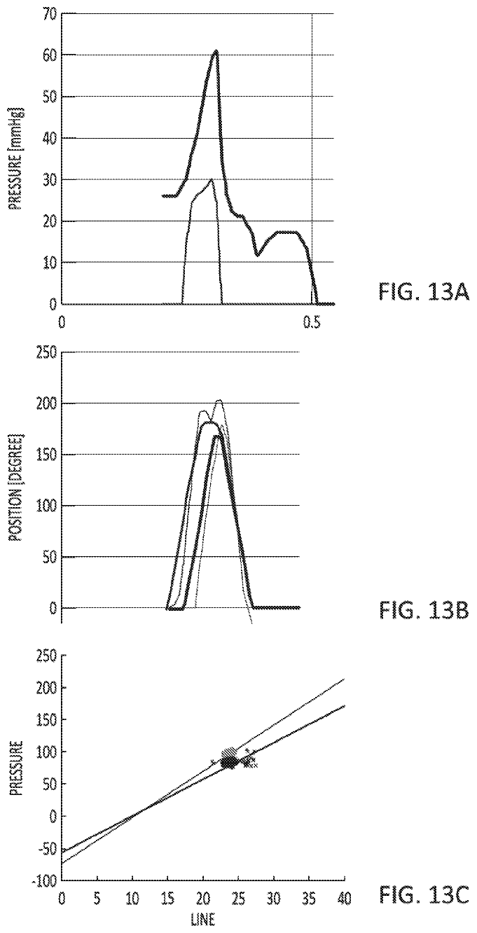

FIGS. 13A-13C illustrate exemplary compression data that can be sent to and/or viewed by the user and authorized users. FIG. 13A, for example, shows that the compression device generated a rapid compression. The two humps in the top line of the graph shows that a two zone compression can result in a bimodal compression wave, if desired, by actuating the zones sequentially.

For example, integrated, wireless strain gauge plethysmography can be performed using a strain gauge to measure the change in the circumference and volume of the body part, which allows the determination of the volume of blood being pumped. Other techniques can also be used to determine the circumference and/or volume of the treated body part. For example, the drive cord position (i.e. how much of the drive cord is wound up) can be determined by using, for example, a Hall Effect sensor to monitor the rotation of the drive pulley and/or drive shaft. The current draw or load on the motor can also be correlated with drive cord position, and both the current draw and the drive cord position can be correlated with the compression pressure delivered to the body by the system. The compression strap or other closure mechanism position can be similarly determined (i.e. using a Hall Effect sensor or other sensor on the tightening mechanism or monitoring current of the motor if a motor is used to drive the tightening mechanism). Alternatively or additionally, the closure system, such as the compression straps, can have visual indicators or markings indicating the circumference of the body part.

Strain gauge plethysmography or other forms of plethysmography can also be used to determine blood flow hemodynamics, such as blood flow velocity and heart rate. See “Beat-by-beat forearm blood flow with Doppler ultrasound and strain-gauge plethysmography”, M. E. Tschakovsky, J. K. Shoemaker, R. L. Hughson, Journal of Applied Physiology, Sep 1995, 79 (3) 713-719. Other physiological measurements that can be determined include nitric oxide levels, which is a vasodilator and can be determined by using strain gauge plethysmography. See “New Methods to Evaluate Endothelial Function: Method for Assessing Endothelial Function in Humans Using a Strain-Gauge Plethysmography: Nitric Oxide-Dependent and -Independent Vasodilation”, Yukihito Higashi and Masao Yoshizumi, J Pharmacol Sci 93, 399-404 (2003).

Plethysmography can also be used to measure the venous volume and to calculate a venous filling index (VFI). Changes in leg volume can be measured using the compression device around the calf to deliver a pre-set compression pressure with the patient in a supine position. The limb being evaluated can then be elevated to drain the venous system. Once the venous system is emptied, the leg volume is determined by the system and recorded and the patient is asked to stand, after which the change in volume is determined and recorded again. The difference in the recorded leg volume is the functional venous volume. The time needed to fill 90 percent of the functional venous volume is the venous filling time. The venous filling index is functional venous volume divided by the venous filling time; a normal venous filling index is <2 mL/sec. The greater the venous filling index, the more severe the reflux. The residual volume fraction, which is the ratio of the residual volume to the function venous volume, is directly proportional to ambulatory venous pressure, which is used to diagnose venous hypertension. Each one of the parameters, the leg volume, the functional venous volume, the venous filling time, the venous filling index, and the changes of these parameters over time as the treatment progresses, can be used by the treatment algorithm to optimize compression treatment parameters. For example, if an adjustment of compression parameters results in an indication that the patient's condition is worsening, such as an increasing venous filling index, the treatment parameters can be reverted back to the previous treatment conditions and/or further modulated.

In addition, measurement of the circumference and volume of the treated body part may be correlated to healing progression for certain diseases, since as the body part heals, the swelling tends to be reduced, resulting in a decrease in circumference and volume for the treated body part. Data from the sensors can be transmitted and analyzed, using the processors on the compression system itself and/or using remote processing from a smart phone, smart watch, tablet, other computing device, server, or cloud computing network, and compression treatment can be adjusted based upon the data.

For example, an accelerometer or gyro can be used to determine body position, such as when the patient is lying down or standing up. Since there is often a significant difference in diameter and circumference of a swollen leg between the standing and lying down positions, the system can adjust the baseline compression pressure by tightening or loosening the drive cord or the closure mechanism when it detects a change in posture. The system may also include a delay before adjusting the baseline pressure to accommodate the lag or delay between a change in posture and a resulting change in the diameter/circumference of the body part, and to avoid changing the baseline pressure for a short duration change in posture.

The system can analyze personal health data that is collected and recorded from the patient, such as data in the patient's electronic health record and the data collected by the sensors during treatment, which includes compression treatment parameters such as compression/pressure magnitude, duration, and frequency along with patient compliance, and compare and correlate the compression treatment parameters and dosing with healing response and disease state outcomes or progression which can be monitored by the system as described herein. Treatment parameters and dosing can be modulated, and healing response and disease state outcomes can be monitored to determine whether the modulated parameters resulted in improved outcomes or healing response (e.g., reduced body part circumference, diameter, and/or volume).

In addition, the system can access population health data that is compiled from a variety of sources, such as medical studies, hospital data, and data recorded from a population of patients using the systems and devices described herein or other compression devices. The population health data can include data regarding the treatment given to the patient, the treatment outcome, healing progress, patient compliance, and demographic data such as the patient's age, race, sex, and other medical conditions. The system can analyze the population health data to find the treatments that resulted in the best outcomes in patients that have a similar background or demographic and can modulate the current treatment parameters based on those treatments.

The system can also access reference data, such as geolocation, income, and weather.

The data analysis can be performed by a variety of computing devices, such as on a smart phone, tablet, laptop computer, or desktop computer that is maintained by the patient. In some embodiments, the patient controlled computing devices can analyze patient health data and use such data to modulate treatment parameters. Analysis of data can also be done on remote computing devices, such as servers or cloud computing networks, which may be better suited to perform data analysis of population health data in addition to analysis of personal health data. In some embodiments, patient controlled devices may analyze both personal health data and population health data.

Important data streams that can be sensed, monitored and/or recorded by one or more sensors on the device or independent of the device and used to by the treatment algorithm to modulate treatment include compression pressure delivered to the patient, blood pressure, compression dose (i.e. compression level/magnitude, compression duration, frequency, dwell time, treatment duration), patient's position (standing versus lying down), leg girth, activity level, venous filling time, venous volume, venous reflux, venous index, ulcer status, heart rate, oxygen level (measured using pulse oximeter for example), temperature, auditory cues such as snoring, blood flow, and ischemia. For example, oxygen levels in the lower leg and/or foot can be correlated to the ability to pump blood.

In some embodiments, the compression device can include a plurality of positional sensors located throughout the device, such as against the shin on the foam padding, on the compression plate against the back of the calf, on the compression straps, on the compression sleeve, etc., so that a 3-D map of leg or body part can be constructed, which allows the leg or body part volume to be derived and allows the change/reduction in volume to be determined over time.

The mobile/wearable compression system and method can incorporate artificial intelligence, fuzzy logic, machine learning and/or other decision algorithms for determining and/or adjusting the treatment parameters based on feedback from the sensor data and analysis and comparison with personal health data and/or population health data. An onboard microprocessor system can be programmed to “learn” and adjust therapy based upon the integrated sensor data stream. The mobile/wearable compression therapy system is capable of monitoring compliance with the prescribed treatment algorithm by, for example, logging usage of the device and comparing it to the prescribed treatment regimen. An interactive compression therapy system can be provided that is capable of asking patient questions via graphical and text user interface and/or audio questions and prompts. The compression therapy system may adjust, adapt, and/or modulate treatment based upon user input or analyses of user input. For example, the patient may indicate that the treatment is not working well, and the system may then initiate a more aggressive treatment schedule by increasing the magnitude of the compression and/or the frequency of compression, and/or the duration of compression (i.e., increasing the compression dosing).The patient may input data, submit/upload pictures and/or input other information related to treatment. The data can be used to refine treatment based upon that data.

The compression therapy system, and/or a computing device, server, or cloud computing network associated with or part of the compression therapy system, may send patients reminders via text, phone, and/or email regarding their treatment or compliance with their treatment. The compression therapy system, and/or a computing device, server, or cloud computing network associated with or part of the compression therapy system, may be programmed to send caregivers, family or loved ones updates on therapy via text, phone and/or email. The compression therapy system may upload treatment data from the compression device on a prescribed schedule, such as at the end of a prescribed treatment, or at regular intervals during treatment, such as about every 1, 2, 3, 4, 5, 10, 15, 20, 25, 30, 35, 40, 45, 50, 55, 60, 90, 120, 150, or 180 minutes, or at prescribed times of the day, such as once a day at 8 pm, for example. In some embodiments, the data may be uploaded continuously or in real-time during treatment. The system and method can use real time data and/or stored historical data acquired from a population of patients using compression therapy to adjust the treatment of some or all of those patients.

The system may have remote control capability for controlling the compression therapy system that allow a caregiver or other authorized person to be able to change the treatment algorithm and/or parameters remotely. For example, remote control may include operating the compression device using a smart phone, tablet, or other computing device. These remote control devices may be paired directly with the compression device, and/or may communicate wirelessly or through a wired connection with a device that has already been paired with the compression device, such as a smart phone that has been paired with the compression device. Authorized persons other than the patient, such as an authorized health care provider, may control or modulate administration of treatment and may review recorded data to verify treatment compliance. For example, a physician may modulate the treatment prescription based upon compliance, ulcer healing progression, and data from strain gauge plethysmography, which may be used to measure the circumference and volume of the treated body part which can be correlated to healing progression since as the body part heals, the swelling tends to be reduced, resulting in a decrease in circumference and volume.

The compression therapy system may “reward” patients for treatment compliance with positive reinforcement via verbal, text or email, for example. The system may also tabulate patient compliance and generate credits redeemable for gifts, prizes, or discounts or rebates that can be applied to medical fees and/or insurance fees such as copays and/or deductibles, for complying with a physician directed course of treatment. The system may provide the patient with automated reminders and instructions for using the system. The compliance data may be accessed by the patient and/or health care provider. Notifications can be provided to the patient and/or health care provider when the patient is out of compliance (i.e., missed a scheduled treatment).

The system can include a social network component. For example, the system can provide updates to social networking sites regarding the status of the treatment and the treatment compliance of the patient. A social hub can be created for patients that are using the treatment to discuss their treatment and to provide support. In addition, the social hub can create a competition or leaderboard that rewards patients that meet treatment compliance levels.

The compression therapy system may be capable of modulating between a “passive” mode at specific set point and “active” mode at specific compression function. In the “passive” mode the compression therapy system can act similarly to a passive compression stocking to deliver a static amount of compression to the body part, except that the pressure or tension delivered by the compression system can be specified and maintained, even in the body part changes size as the result of posture and time, such as caused in the leg by standing upright versus laying down for sleeping, which can be detected using an accelerometer or gyro, for example. Light compression can provide less than 20 mmHg of pressure; moderate compression is between 20 to 40 mmHg, strong compression between 40 and 60 mmHg and very strong compression can be over 60 mmHg The “active mode” has been described herein and provides active, cyclical compression of the body part according to prescribed treatment parameters, such as compression pressure magnitude, duration, and frequency, and overall treatment duration. Active compression can be provided while the patient is awake during specified times and/or upon initiation by the patient, while passive compression can be provided between active compression treatments, while the patient is asleep, and/or upon initiation by the patient.

Monitoring systems capable of notifying caregiver/manufacturer remotely of system malfunctions and/or need to replace components, and to automatically order and send those components to the patient/caregiver, can be integrated into the compression therapy system. The system may be capable of “learning” patient habits and adjusting treatment for convenience, comfort or efficacy of treatment based upon real-time and/or historic capture of diagnostic information.

For example, the system can identify wake and sleep patterns and activity patterns for the patient and can initiate treatments, such as active compression when the patient is awake, and passive treatment when the patient is asleep, or activate treatment when the patient is typically active and standing. The system can also identify what times compression treatments are most effective, as measured by reduction in leg girth or volume for example, as prioritize or direct compression treatment to those times.

The basic principle of operation of one embodiment is: two custom modified battery-powered brushless servo motors drive a single drive cord that is routed over a plurality of pulleys to sequentially pull and release one to six compression straps per motor. Two motors define lower calf and upper calf regions, activated sequentially to obtain natural, sequential compression from the lower to upper calf. The control unit, including electronic control systems and battery can be detached from the stocking, leaving the compression straps at a pre-defined compression level in a lightweight stocking mode.

The prototype electronic system is powered by a Raspberry Pi® zero that can support multi-client web access and local storage capability. The Raspberry Pi component can be replaced with a custom ASIC that incorporates all the needed components of the Raspberry Pi. Running the controller is a version 3.2Arduinio® platform, which can be replaced with custom ASIC and/or software. Voltage, current, Hall Effect, Wi-Fi and/or Bluetooth, force sensitive resistor (FSR) and tilt sensors allow efficient power control, positional sensing of bands, patient posture monitoring, and remote control and monitoring.

The proposed instructions for use for one embodiment are:

1) microfiber breathable soft stocking is pulled over leg, by for example, first releasing the front drawstring (running over pulley system to make release and tensioning easy), 2) pull compression device over stocking on lower leg, soft handles help user hold in place while positioning the device on alignment marking on the stocking, 3) tighten attachment system of compression device until movable pulleys are positioned against the physical stops and optionally until the compression device indicates appropriate pre-tension is achieved through an indicator, which can be auditory or visual 4) activate pre-tension routine on smart-phone to achieve appropriate set-point 5) active/passive compression routine activated, 6) release button and pre-tension released, 7) attachment system can be released and stocking removed. For cleaning, the motor drive module can be removed and stocking washed in washing machine.

Utilizing tension band positional, strain, current draw and pressure data, the device can incorporate strain gauge plethysmography capability, where the volume changes of the limb in response to applied pressure facilitate venous disease diagnosis. This would be very useful as it can be used to actively monitor progression of treatment and adjust if needed. Caregiver could remotely monitor real-time treatment progress and compliance. Ideally, this allows the clinicians to remotely make changes and schedule patients for visits based upon objective treatment data. This would reduce the burden on providers and facilitate better outcomes for this significant population of patients. This system also has significant market potential beyond venous ulcer treatment as it can be optimized for other conditions in which IPC is proven but compliance is low including DVT prophylaxis, lymphedema and peripheral arterial disease.

Current embodiments of the Radial system can achieve up to about 90 cm/s venous blood flow velocity in the veins in the legs. Pneumatic systems cannot achieve these venous blood flow velocities because of the long time it takes to fill the gas bladders, typically about 1 to 3 minutes, whereas the Radial system can deliver full compressions at a frequency of up to 1 Hz or more, such as up to 2, 3, 4, 5, 6, 7, 8, 9, and 10 Hz. Initial testing using the smart phone interface and remote Wi-Fi or Bluetooth control of the system has been successful with pre-tensioning, cycling and release modes achieved. Initial testing has demonstrated successful proof of concept that the Radial Medical SVS system is capable of delivering uniform and clinically meaningful pressures with fully functional remote control and monitoring.

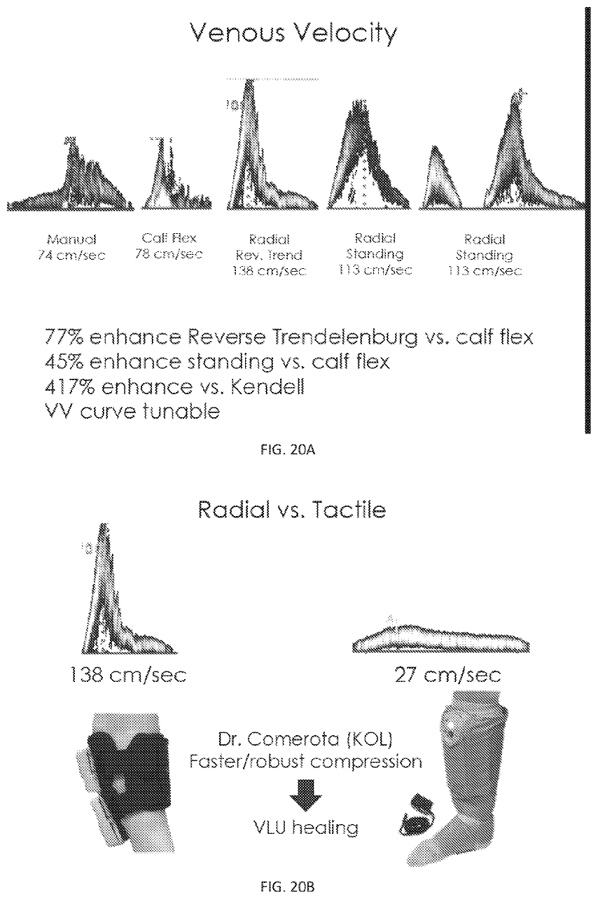

FIG. 20A illustrates the venous velocity profiles that are achieved under various conditions, including natural calf flex, manual compression from squeezing the lower leg with a pair of hands, and the compression device described herein with the patient in a reverse Trendelenburg position or standing. This data shows that the compression device described herein can generate venous velocities up to greater than 77% more than the typical velocities achieved during calf flex. In the standing position, the compression device generates velocities of up to 45 greater than calf flex, and up to 417% greater than the pneumatic compression device shown in FIG. 20B.

The data also shows that a two zone compression device can result in two velocity peaks, depending on the timing between the two zones, with the greatest venous velocities achieved with the first zone of compression. The velocity profile can be controlled and modulated by adjusting the timings between the zones and the magnitude and speed of compression delivered by the pulley based drivetrain. For example, slowing the rotational velocity of the motors will result in a slower rate of compression and a lower venous velocity (lower peak) and a lower change in velocity (lower slope on graph). Similarly, reducing the amount of rotation of the motor during a compression cycle will reduce the amount of line or movable pulley travel, which reduces the amount of compression delivered which results in a lower venous velocity.

Since a single motor may be able to generate sufficient compression and venous velocity, some embodiments of the compression device utilize a single motor that drives compression in one or more zones of compression.

User Interfaces

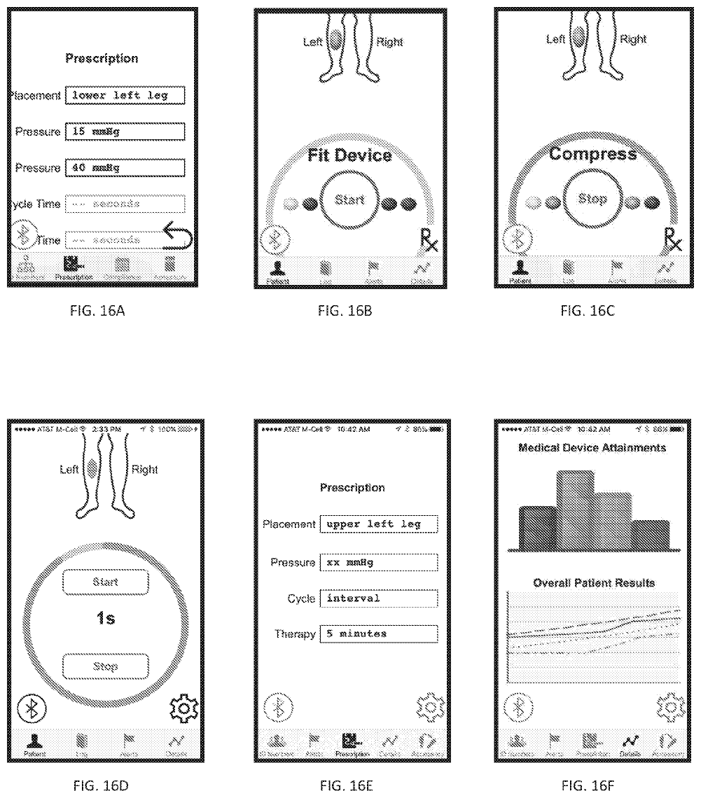

FIG. 11 provides one illustrative user interface displayed on the screen of a smart phone. A variety of other user interfaces including some graphical user interfaces (GUI) are provided in other embodiments. Additionally, still other user interfaces and computer program types will provide additional different modes of control, monitoring and delivery of the desired compression therapy or to perform other functionalities with a compression device embodiment as described herein. In still other embodiments, additional or alternative steps of user interaction or user data collection, monitoring, processing or use will be attained including modifications to the methods illustrated and described in FIG. 12 As such, in some embodiments, the compression device can be controlled and/or monitored using a computing device, such as a computer, laptop, tablet computer, or smartphone. FIGS. 16A-16F illustrate additional variations of a user interface that may be displayed on a display or screen of the computing device. In some embodiments, the display or screen can be a touch screen. In other embodiments, the user interface can include a keyboard and/or mouse. The user interface can have a menu along the edge of the display that allows to user to switch between a plurality of different functional screens. In the illustrative embodiments of FIGS. 16A-16F, there is a touch enabled menu along the bottom edge. In FIGS. 16A and 16E, an exemplary prescription screen is illustrated. An exemplary prescription screen allows the user specify the treatment parameters such as the placement location of the compression device, the treatment pressures (i.e., baseline pressure and active pressure), the cycle type and times, and the therapy duration, for example. In some embodiments, the user can select the parameters from a drop down menu that presents available options for the patient to select. In the exemplary screen shot of FIG. 16A, the placement, pressure (top), pressure (bottom), cycle time and treatment time as shown and may be provided by entry, pull down or auto fill based on other patient data, physician provided set points, historical data or trends and the like. In FIG. 16E, the placement, the pressure, the cycle and the therapy fields are shown. In this view a gear icon is displayed to permit access to system functions and other controls depending upon configuration.

FIGS. 16B, 16C and 16D illustrate selection of a patient icon in the user interface. In each of these various views, an icon of the portion of the body where the compression device is interacting is provided. The body portion is annotated with the location of the device relative to that body portion. The patient body portion icon may change to reflect the use of the compression system for other applications and body portions as described herein. In these illustrative embodiments, the compression device or devices are on the lower limbs. The body portion icon may show only the active, selected compression device (as shown) or may include all devices with a section option for interaction with or display of parameters from one specific device.

FIG. 16B illustrates an exemplary user interface screen for operation of a “Fit Device” user action procedure. In the “Fit Device” user action procedure the system can provide the user with a step-by-step procedure with both text and illustrations for fitting on and calibrating the system, as further described herein.

FIG. 16C illustrates an exemplary user interface screen for operation of a “Compress” user action procedure. In the “Compress” user action procedure the system initiate a compression cycle according to the parameters set by the user. This may be a test screen that allows the user to test various compression parameters, or it may be used as a manual mode to provide compressions on demand.

FIG. 16D illustrates an exemplary user interface screen to display the monitor for a specific compression cycle status. Start and Stop icons are provided for showing when compression is being applied. Compression duration is displayed between the start and the stop buttons. A rim around the start and stop buttons changes display as the compression cycle proceeds either by showing each system or for the elapse of a compression therapy session.

In one aspect, one or more compression therapy parameters determined by a health care provider is transmitted to the memory of the compression device and auto fills one or more fields, parameters, characteristics or mode of a patient specific compression therapy protocol. In some aspects, a health provider determined compression protocol is loaded electronically by scanning a prescription or reading a physician provided code with a device associated with the compression device or the user.

Other functional screens include a details screen that displays treatment data to the patient. The data can be displayed graphically in bar or line graphs, for example, and/or can be displayed in a table. The overall patient results and the medical device attainments (i.e., usage data) can be shown.

FIG. 16F provides a representative output screen illustrating a number of graphical parameters based on compression therapy sessions and progress of a user. The top portion of the display may illustrate usage data and/or sensor data. Also shown in this view is a graph showing the therapy progress over time, which can be the change in leg girth and/or leg compliance, for example. Exemplary parameters for display include any of the parameters disclosed herein such as blood pressure, compression dose (i.e. compression level/magnitude, compression duration, frequency, dwell time, treatment duration), patient's position (standing versus lying down), leg girth, activity level, venous filling time, venous volume, venous reflux, venous index, ulcer status, heart rate, oxygen level (measured using pulse oximeter for example), temperature, auditory cues such as snoring, blood flow, and ischemia.

In some embodiments, the user interfaces described herein allow the user to monitor therapy progress both while the compression device is on or off. In some embodiments, a passive compression sleeve with embedded sensors can be worn when the compression device is not worn so that the various parameters described herein, such as leg girth and leg compliance for example, can still be monitored even when the compression device is not being actively used.

In some embodiments, a physician or artificial intelligence or smart computing program can have access to one or more of the display screens as well as the underlying data. The physician may view the data over the cloud through a physician portal on any type of computing device, such as a smartphone, laptop computer, desktop computer, or tablet. After accessing the data and determining the progress of treatment, by examining leg girth and leg compliance data for example, the physician/AI can adjust the compression therapy parameters in real-time. The physician/AI changes can be sent to the user's smartphone wirelessly though a cellular network or internet network, which can then communicate and update the compression device parameters.

In some embodiments, certain data and/or certain user interface screens can be password protected. In some embodiments, there can be separate, password protected screens for the user, the physician, the caregiver, the therapist, the coach, etc. In some embodiments, the user and/or physician can give access to various password protected screens to other users.

Another functional screen can be the patient treatment screen which can display graphically and/or in text the location of compression device (i.e., lower left leg, lower right leg, upper left leg, upper right leg, etc.) during treatment, the steps for the patient to perform (i.e, fit the device to the body part, tighten the compression straps, etc.), start treatment, stop treatment, the treatment step being performed (i.e., compress, relax, the duration of the step, the time remaining of the step, etc.).

Graphical icons with optional text can be used to navigate between the various screens. Other screens include an alert screen to view alerts, error codes, and to set up alerts and reminders to perform treatment, an accessory screen to purchase accessories for the compression device, an identification screen to register the compression device with the application, a log screen, and a patient compliance screen.

In some embodiments, the user log screen allows the user to enter and upload any comments that the user deems relevant to the treatment. The log screen may also allow the user to rate various objective and subjective metrics regarding the treatment and/or compression device, such as usability, comfort, and efficacy.

In some embodiments, the compression device itself can include a user interface 2310 that can include a touch pad and/or button type user interface as shown in FIG. 23C, with a display being optional. In some embodiments, an accelerometer can be used as an on/off switch by detecting unique tapping patterns. In some embodiments, an icon or target or other identifying mark is provided on portion of the housing for this purpose. An outer shape, feature or contour or other tactile feature may aid in interaction with the device when worn under clothing.

### Compression Device Configured for Sports or Activity Related Recovery and Injury Recovery

In still other alternative configurations, one or more or a combination of the compression devices or methods of operation of one or more compression devices described herein may be scaled in size, modified, or adapted to be suitably configured to provide compression therapy to aid in sport preparation, sport training or recovery after activity specific, sports or athletic exertion. In these various embodiments, the compressive forces delivered by the one or more compression devices is aligned with muscle groups, joints or soft tissue to provide massage to affected areas alone or in combination with other affected regions as a result of the completed activity. In some configurations, one or more compression devices are adapted for use in blood flow restriction (BFR) training.

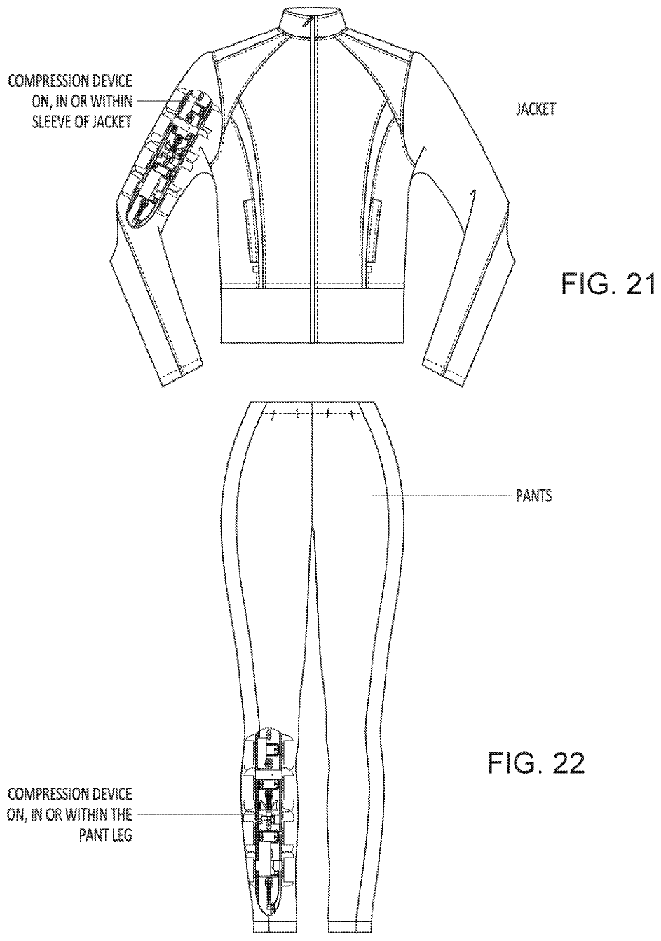

In one aspect, the one or more compression devices provided for this purpose are oriented and grouped according to the degree and manner of compression therapy suited to the desired outcome such as lactic acid removal, fluid removal, swelling, muscle fatigue and the like. As a result, the compression device or groups of devices are aligned to provide compression therapy or massage to affected areas. The compression devices may be placed on the affected area directly or incorporated on, in or within a suitable garment with a form factor appropriate to ease of donning and doffing while retaining the compression device in position for a particular therapy session. Exemplary garment form factors include, by way of example, a total body coverall, a jump suit, a pair of pants, a pair of shorts, a jacket, one or set of sleeves, gloves, boots, shoes, stockings, socks or a wrap. Exemplary compression devices are illustrated on, in or within a sleeve of jacket (see FIG. 21) or the leg of pants (see FIG. 22). In various embodiments, individual compression devices may be linked together wirelessly or via wired connections to a central compression controller that operates the drive or drives on each associated compression member according to the overall desired therapeutic effect as well as the specific location of a compression member in relation to other compression devices.

The compression device or combination of compression devices for a particular limb are applied to the associated region of the body or regions of the body in any combination in relation to the therapy sought in relation to the completed activity, sport or athletic event. Thereafter, each of the compression devices is activated in a predetermined sequence which applies controllable, repeatable pressure to the muscles, vasculature and soft tissues including the lymphatic system in any desired sequence depending upon desired clinical results or patient specific needs such as pain, discomfort, localized swelling of a body part or limb. In one aspect, the one or more compression devices is activated in a serial compression mode. The serial compression mode of controllable compression therapy acts on the associated muscles and veins to mimic the action of walking As a result of serial compression mode operation, blood is moved through the veins towards the heart so as to prevent pooling of blood in the lower limbs. Additionally or optionally, the mode of operation of one or more compression devices may be to move fluids away from the heart or to provide compression at levels associated with massage—ranging from gentle to firm to deep tissue, based on degree of compression applied.

Still further, configurations of one or more controllable compression devices may be used to create gradient compression on the limbs to provide a massaging effect to imitate natural fluid flows toward or away from the core, or toward or away from an extremity as desired in a particular therapy. It is to be appreciated that the one or more controllable compression devices may be adapted and configured to vary the amount of compression, rate of the application of compression, hold time for compression, release time/rate of compression for each compression device operating alone or in conjunction with one or more other controllable compression devices as described herein. In one aspect, the one or more compression devices are applied to the patient and then sequentially operated to provide a gradient of pressure in the leg or any limb by adjusting the compression profile of each of the controllable compression devices. Moreover, the duty cycle of the compression cycle includes a compression period and a relaxation period. In one embodiment, the compression cycle is 10 seconds, 15 seconds, 20 seconds with a relaxation cycle of from 60 seconds or more between successive compression cycles. In some embodiments, the compression cycle is timed to operate in sequence with all or a portion of the patient's heartbeat.

Exemplary activity, sports and athletic recovery configurations include, for example, (a) compression devices worn on both legs and operated in sequence to provide compression therapy to a portion of the muscles, joints, soft tissue or lymphatic system in the legs; (b) compression devices worn on both legs configured with a support garment in the form of pants and operated in sequence to provide compression therapy to the muscles, joints, soft tissue or lymphatic system in the legs; (c) compression devices worn on one or both arms and the chest and operated in sequence to provide compression therapy to the muscles, joints, soft tissue or lymphatic system in the arms and the chest; (d) compression devices worn on worn on one or both arms and the chest and operated in sequence to provide compression therapy to the muscles, joints, soft tissue or lymphatic system in the arms and the chest configured with a support garment in the form of a jacket; (e) compression devices worn on one or both arms and operated in sequence to provide compression therapy to the muscles, joints, soft tissue or lymphatic system in the arms; (f) compression devices worn on worn on one or both arms and operated in sequence to provide compression therapy to the muscles, joints, soft tissue or lymphatic system in the arms and configured with a support garment in the form of jacket sleeves; (g) compression devices worn on one or both hands and operated in sequence to provide compression therapy to muscles, joints or soft tissue of the hands or fingers; and (h) compression devices worn on one or both hands and operated in sequence to provide compression therapy to muscles, joints or soft tissue of the hands or fingers and configured with a support garment in the form of gloves or mittens.

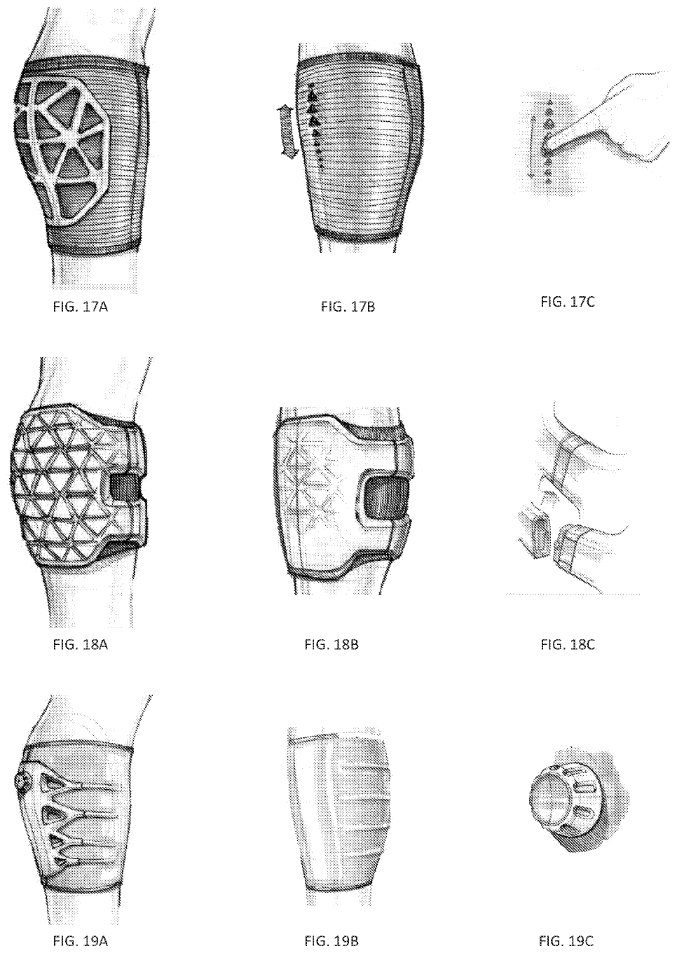

FIGS. 17A-19C illustrate various embodiments of compression devices that may be used for sports and athletic recovery applications as well as the other treatments described herein. In general, the non-electrical components, such as the compression sleeves/elements are form fitting, comfortable, and easy to put on and take off. The device can be worn under clothing or can be exposed. The non-electrical components can be easy to clean and may be machine washable. An embedded interface and sensors allow data collection and tracking using a mobile application. FIGS. 17A-17C illustrate an embodiment of a compression device that has been integrated into a compression sleeve with circumferentially arranged compression lines that can be tightened and relaxed using the pulley based drivetrain described herein. The tightness of the compression sleeve can be adjusted using a capacitive touch based interface than can be disposed directly on a portion of the compression sleeve. In some embodiments, the tightness can be adjusted by swiping the interface, where one direction results in tightening and the other direction results in loosening. This integration allows the device to achieve a much slimmer and more conforming and form fitting form factor. The compression sleeve can utilize densely packed geo ventilation patterns (e.g., triangle or circle cutouts) to enhance breathability.

FIGS. 18A-18C illustrate another example of a compression device with a form factor that resembles an athletic knee pad or exoskeleton that can be worn over various body parts. The compression device may include a compression sleeve and may be fastened to the body part using circumferential snap fittings or magnetic buckles. A ratcheting mechanism can be used for tightening and a release button can be used to release the tension from the ratcheting mechanism. The exoskeleton portion can be disposed over the housing of the compression device and/or over portions of the compression sleeve and can be formed from extruded, semi-rigid forms with a faceted geometry. The exoskeleton portion provides increased protection and support without loss of comfort and allows prescribed flexure and folding to accommodate motion.

FIGS. 19A-19C illustrate yet another example of a compression device that also uses a compression sleeve with integrated compression lines integrated into the sleeve. The tightness of the sleeve can be adjusted using a rotary knob based ratcheting system that can be disposed on the housing of the compression device, which is typically worn on the front facing side of the body part for easier access. In this embodiment, some of the internal workings of the compression device, such as some of the tensioning components, are exposed and visible to the user. This allows the user to view the tensioning and contraction of the tensioning components.

In sports recovery applications and heavy activity recovery applications and to treat fluid buildup symptoms, injuries and disorders such as swelling and lymphedema, multiple compression devices can be worn and used to sequentially pump body fluids, such as lymph, away from the body part. As described herein, the compression devices can be in communication (e.g. wirelessly) with each other to facilitate the sequential compression that moves from a distal portion of the body part (i.e., lower leg or lower arm) to a more proximal portion of the body part (i.e., upper leg or upper arm). Multiple devices can be worn sequentially along the length of the body part that is to be treated.

Sequential compression is also useful for treating soldiers out in the field to improve recovery rates and improve performance and to treat injuries. Whereas pneumatic compression devices generally utilize a large compressor that is bulky and heavy and is not portable, the pulley based compression devices described herein are compact, lightweight and portable. A soldier can easily carry one or more portable, active mechanical compression devices when out in the field to use during periods of downtime.

The portable, active mechanical compression devices described herein are also useful to many other users, such as travelers and athletes, for example.

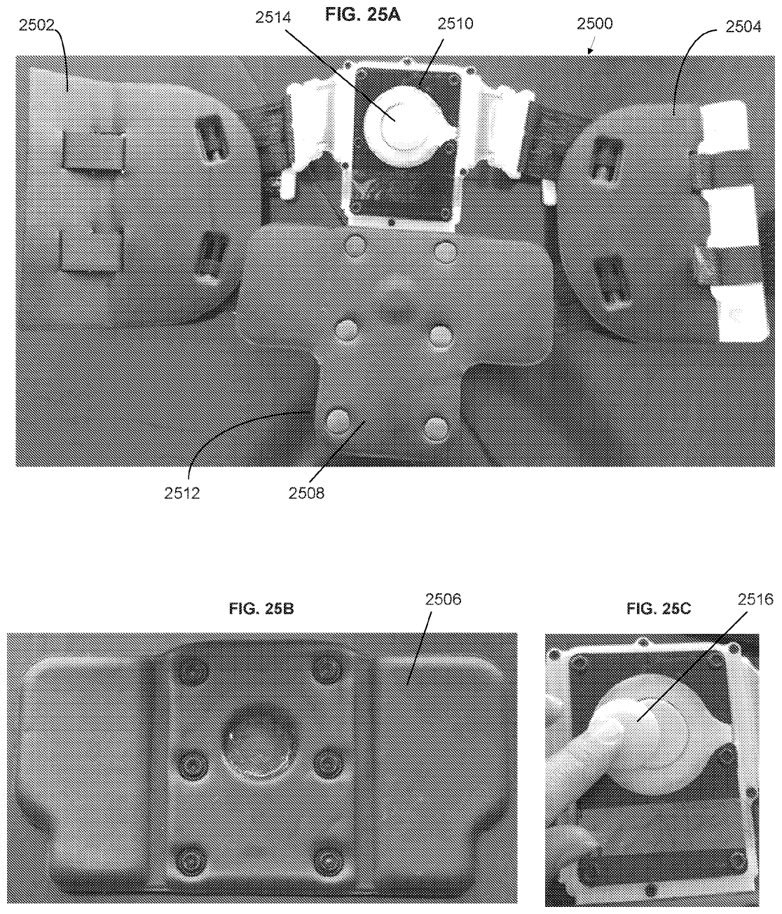

FIGS. 25A-B illustrate another embodiment of a compression device 2500, showing the cushioned components on a back portion of the device, closest to a user. As described above, the cushioned components comprise backing components 2502, 2504, and pads 2506, and 2508 (FIG. 25B) positioned on the back of each compression plate 2510, 2512. The top compression plate 2512 is shown without its corresponding pad 2506 to allow viewing of the force sensor 2514 positioned within the compression plate. In some embodiments, the force sensor 2514 can be used with a protruding component 2516 (FIG. 25C). The protruding component 2516 can be shaped like a puck or disk, as shown in FIG. 25C. Other shapes are also possible (e.g., spherical, ovular, etc.), as long as the shape provides sufficient surface contact against the force sensor 2514. The protruding component 2516 can provide a better surface than the force sensor alone upon which the measured forces within the compression system can act, concentrating the forces on the protruding component 2516. The pad 2506 that goes over the compression plate 2510, force sensor 2516, and protruding component 2516 can comprise a depression 2518 configured to match the shape of the protruding component 2516. This depression in the pad can allow better contact between the protruding component 2516 and the user skin or stocking. In some embodiments, a thickness of the pad between the user and the force sensor is about 0.020″ (e.g., about 0.015-0.025″). While the force sensor 2514 is shown as being round and the protruding component disk or puck shaped, it will be appreciated that other shapes for the force sensor, and correspondingly, for the protruding component 2516 are also possible.

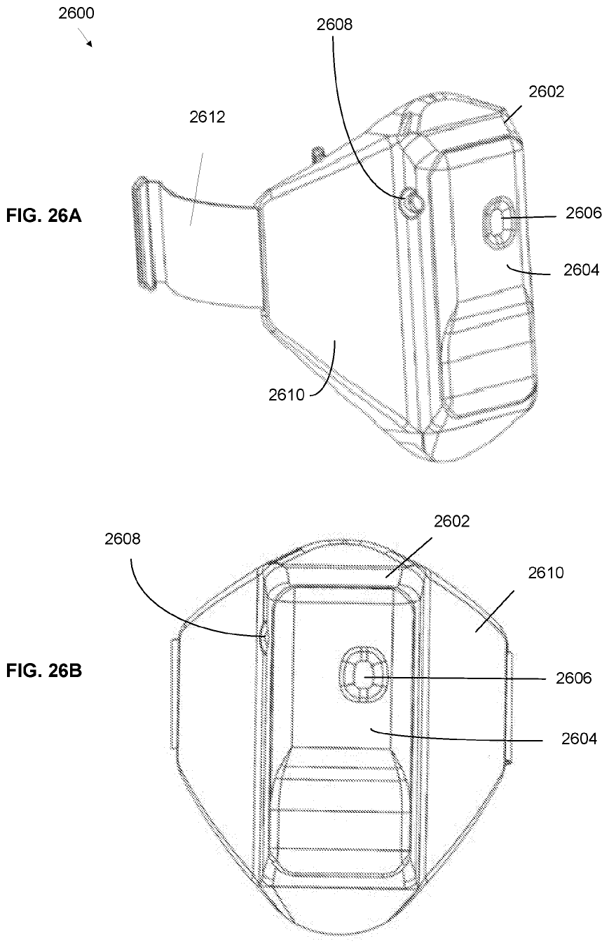

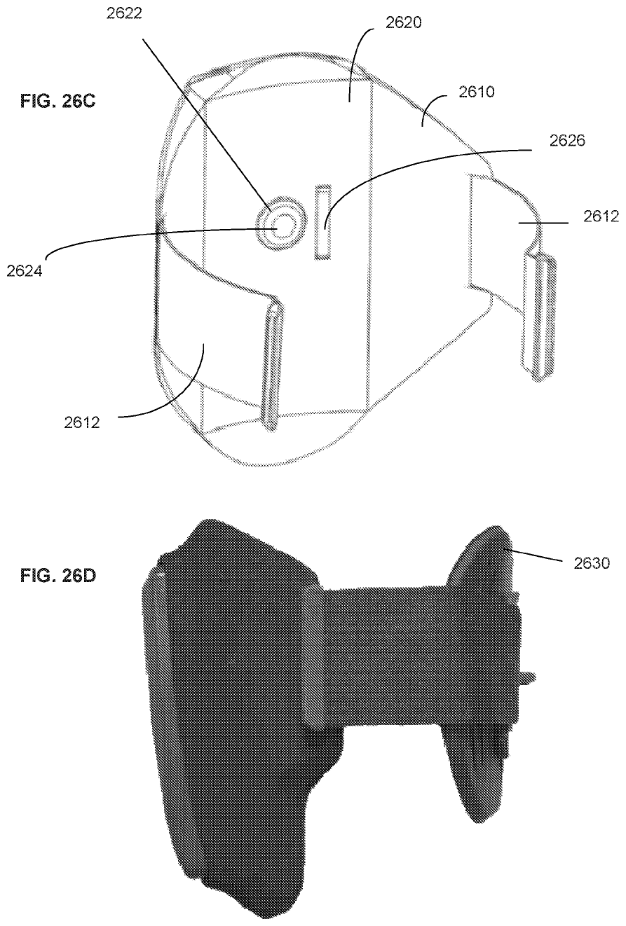

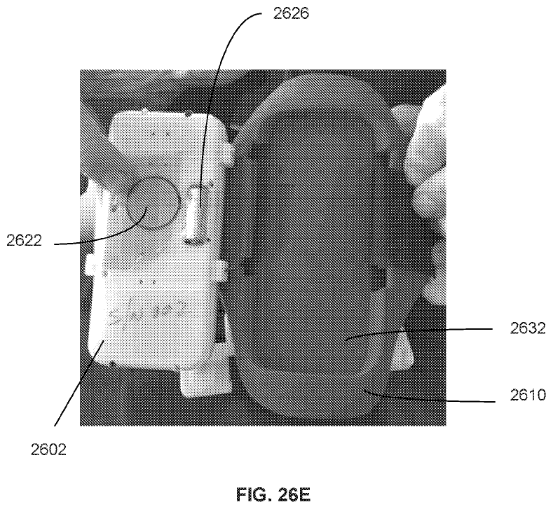

FIGS. 26A-C provide front perspective, front, and back perspective views of another embodiment of a compression device 2600. Unless otherwise described, the device 2600 comprises features similar to those described with other compression devices described herein. The device 2600 comprises a housing 2602 positioned on a front portion of the device 2600. The housing 2602 can house the motor and pulley system, such as those described herein. In some embodiments, the device 2600 comprises a single motor. Additional motors are also possible. The housing 2602 can also comprise the electronic, connectivity, and power source components, as described herein (e.g., with respect to compression systems 300). In some embodiments, port 2608 can be used to charge the device 2600. In other embodiments, inductive charging can be used. A front portion of the housing can comprise control portion 2604 of the device. The control portion 2604 of the device can comprise a capacitive touch sensor 2606 that can be used to control operation of the device 2600.

The housing can comprise a low profile, extending minimally from a surface of a user's body. The edges and corners of the housing can be rounded to provide comfort to the user. The housing can comprise injection moldable thermoplastics or 3D printable materials (e.g., nylon, ABS, etc.). In some embodiments, the housing is about 5-10 inches long. In some embodiments, the housing is about 2-3 inches wide. A weight of the housing can be about 1 lb or less. In some embodiments, a weight of the device can be about 1 lb or less.

The housing 2602 can sit within a cushioned cradle 2610. The cradle 2610 is configured to conform to the body of the user (e.g., on or near the user's calf). The cradle is also used to connect a strap or cuff 2612 to the housing 2602. Tension members extend from the compression system in the housing 2602 through the cradle 2610 and connect to the strap 2612. The cradle 2610 can comprise any cushioning material, such as foam (e.g., EVA, polyurethane foam, etc.)

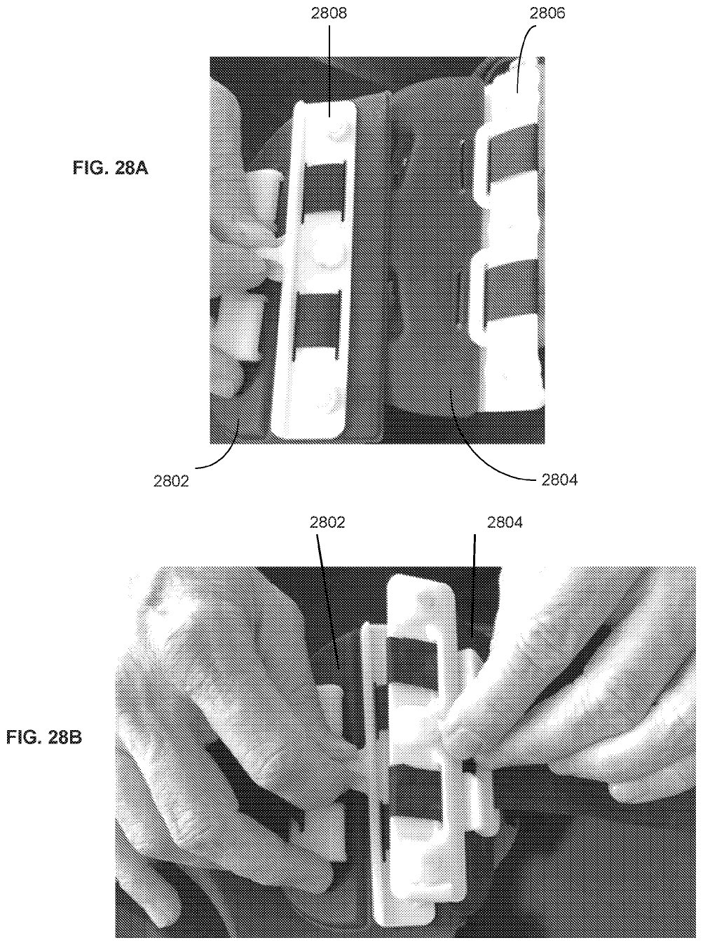

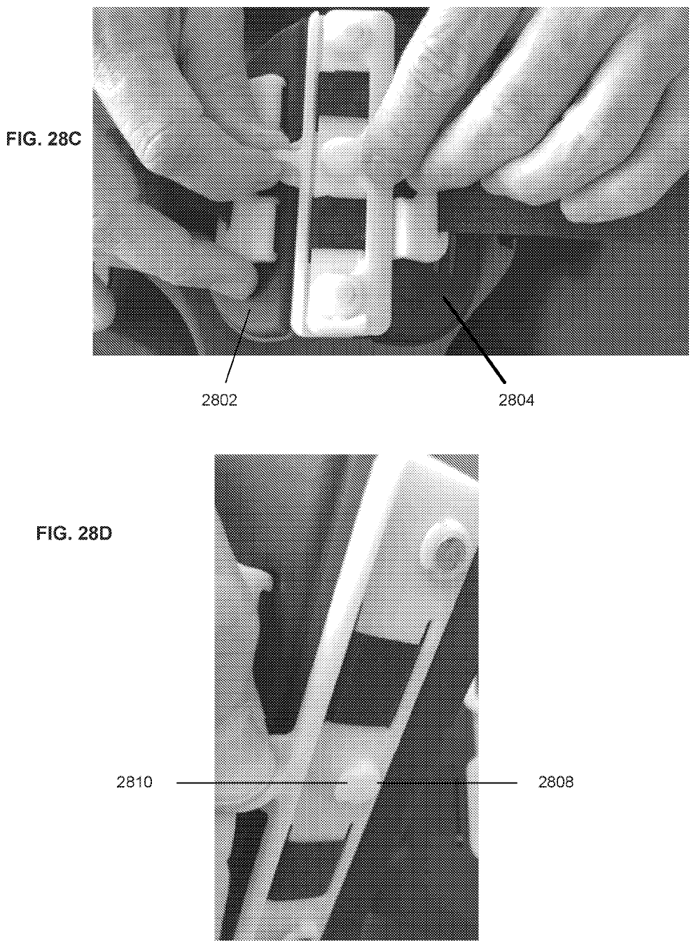

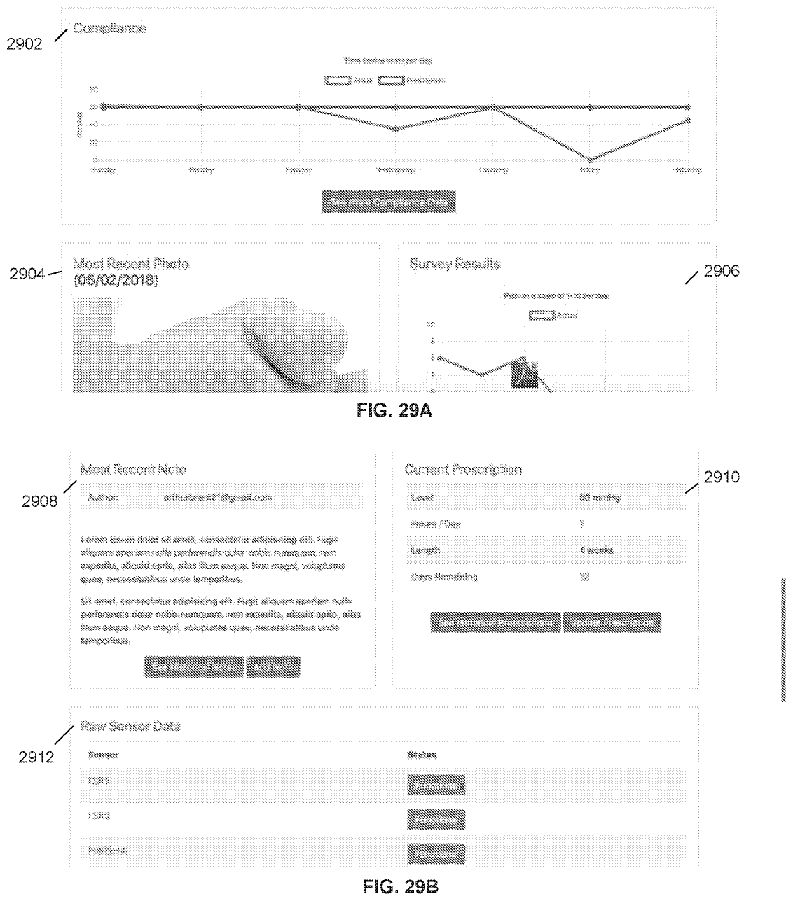

As shown in the back perspective view of FIG. 26C, a back side 2620 of the compression system is exposed through an opening in the cradle 2610. Positioned on the back side 2620 is a force sensor 2622 and a vibrating element 2626. The force sensor 2622 can be used in conjunction with a protruding component 2624, as described above with respect to FIGS. 25A and 25B to enhance the signal to the force sensor. Each strap can connect to a backing component 2630, shown in the side view of FIG. 26D and closure system(FIGS. 28A-D) such as those described herein (e.g., with respect to FIGS. 6A-6O). The straps can comprise hook and loop straps or other clasping mechanisms, such as those described herein. The straps can comprise a travel of about 1-2 cm per strap. As shown in FIG. 26E, the cradle 2610 can comprise a depression 2632 shaped to receive a back surface of the housing 2602. The depression can provide a thin layer of material between the instruments (e.g., force sensor 2622, vibrating element 2626) and the user so as to not dampen signals to and from the instruments. For example, the thickness of the layer can be about 0.010 in (e.g., about 0.005-0.015 in). The layer can be thin enough to provide sufficient and efficacious contact between the instruments and the skin.

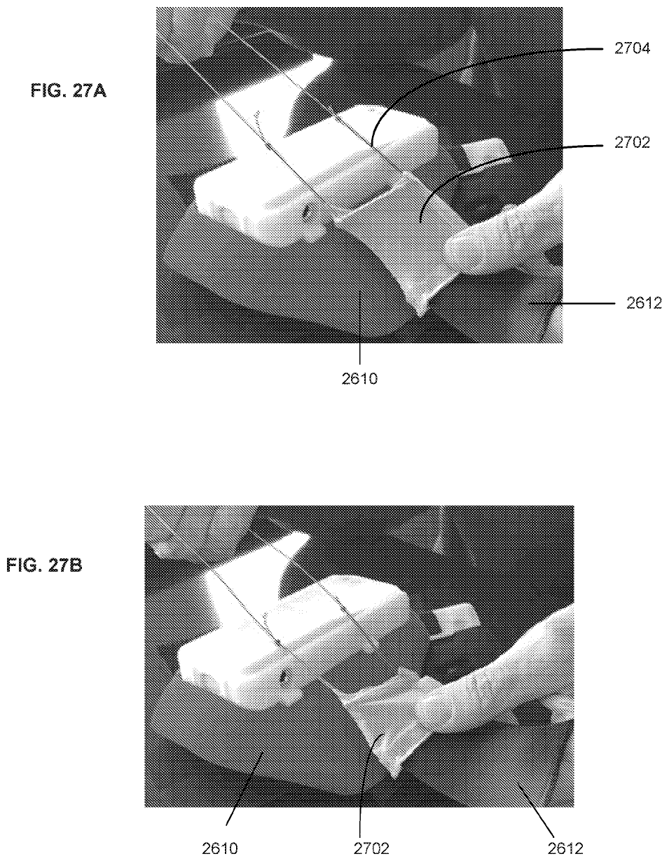

As shown in FIGS. 27A and 27B, similar to boot enclosure 2304 described above with respect to FIGS. 23A-23E, the device 2600 can comprise a feature that provides water resistance and slack management of the drive cord, which reduces the likelihood of entanglement of the drive cord or disengagement of the drive cord from the pulleys. As shown in FIG. 27A, an impermeable and resilient material can be used to form a gasket like boot enclosure 2702. The boot enclosure 2702 forms a waterproof seal at the junction between the cradle 2610 and the strap 2612. The boot enclosure 2702 also serves to form a resilient connection between tensioning members 2704 from the compression system within the housing and the strap 2612. FIG. 27A shows the boot enclosure 2702 in a tensioned, stretched state, while FIG. 27B shows the boot enclosure 2702 in a relaxed state. In some embodiments, the boot enclosure is made of silicone. In other embodiments, the boot enclosures can be made of plastic, rubber, or other flexible and/or elastic materials.

FIGS. 28A-28D show an embodiment of a magnetic closure system for backing components of compression devices described herein (e.g., compression device 2600). As shown in FIG. 28A, the backing component is formed of two sections 2802, 2804, that can be reversibly attached together and detached from each other using one or more magnetic fasteners, each magnetic fastener formed from a female component 2806 and a male component 2808. The female component 2806 can be a receptacle with a magnet for receiving the male component 2808, and the male component 2808 can be a pin or button made of metal that fits into the receptacle. In some embodiments, the male component 2808 can have the magnet and the female component 2806 can be made of metal. The receptacle of the female component can be a keyhole receptacle with a undercut with an overhang portion that secures the male component in the female component when under circumferential tension, but that allows the male component to be removed using a force that is applied in opposition to the circumferential tension (i.e., force brining the tacking components together). FIG. 28B shows the two backing components 2802, 2804 being brought together, prior to being closed. FIG. 28C shows the backing components 2802, 2804 in a closed state. FIG. 28D shows the overhang 2810 on the male component 2808 that can fit into the keyhole receptacle of the female component.

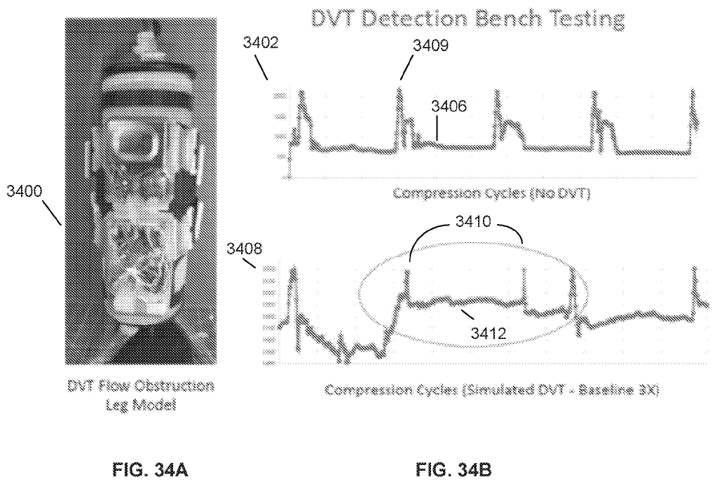

In some embodiments, the force sensor on the system allows for the detection of deep vein thrombosis (DVT). A DVT can cause swelling in the leg, causing the baseline tension in the leg to be higher than that previously recorded. The system can be configured to detect this change in baseline tension, and alert both the user and a clinician that the user needs to go to the hospital. FIGS. 34A shows a device 3400 in bench testing of DVT detection using the force sensor on the compression device. The top graph 3402 in FIG. 34B shows compression cycles without presence of a DVT, showing cyclical spikes in pressure 3404, and then a return to baseline 3406. In the stimulated DVT setting shown in the bottom graph 3408, between the spikes in pressure 3410 representing compression of the device, the pressure returns to an elevated baseline 3412 due to the swelling of the leg caused by the DVT. The system can recognize this kind of pattern as representing a DVT and can alert the user and/or clinicians that the user needs to go to a hospital.

The compression devices disclosed herein can be used to treat restless leg syndrome, which refers to when people experience uncomfortable sensations in their legs (and sometimes arms or other parts of the body) and an irresistible urge to move their legs to relieve the sensations. The condition causes an uncomfortable, “itchy,” “pins and needles,” or “creepy crawly” feeling in the legs. The sensations are usually worse at rest, especially when lying or sitting. The severity of RLS symptoms ranges from mild to intolerable. Symptoms can come and go and severity can also vary. The symptoms are generally worse in the evening and at night. For some people, symptoms may cause severe nightly sleep disruption that can significantly impair their quality of life.

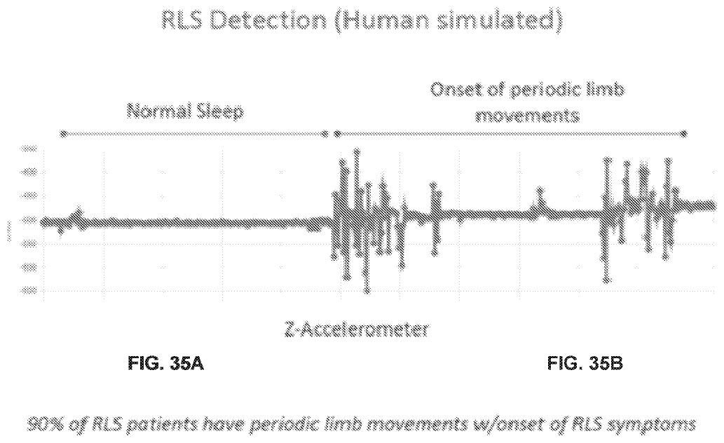

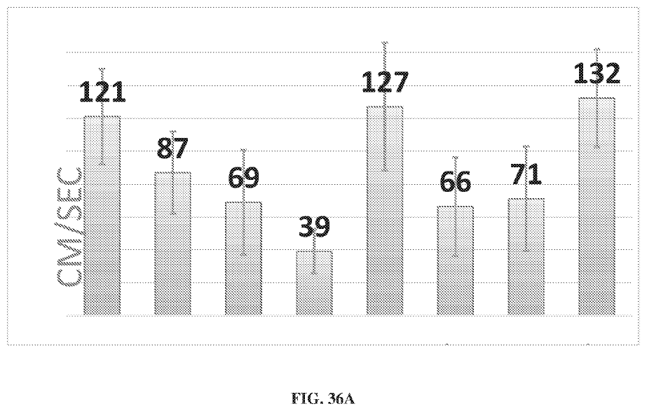

Compression has been shown to be helpful in treating restless leg syndrome (RLS). Vibration has also been shown to address RLS symptoms. The devices described herein can be used to address the symptoms of restless leg syndrome by applying an appropriate level of compression. Once the system determines that symptoms are occurring, compression therapy can begin. The system can determine onset of symptoms manually, using user feedback, or automatically through use of an accelerometer. It has been found that 90% of RLS patients experience periodic limb movements with the onset of RLS symptoms. As such, an accelerometer can be used to detect such periodic limb movements and initiate treatment. FIG. 35A shows data from an accelerometer showing normal sleep (fairly flat pattern) and the onset of periodic limb movements preceding RLS symptoms in FIG. 35B. In some embodiments, the treatment comprises activating the vibrating element and providing compression therapy. The treatment can also comprise one or the other of compression therapy and vibration. The system can vary the pattern of compression and/or vibration applied to prevent the user from adapting to the pattern of therapy, which can lead to a return of RLS symptoms.

Treatment for restless leg syndrome has been found to be very patient specific. The system described herein allows for adjustability of treatment using the user interface (e.g., through an app on a smartphone). A user can adjust intensity, duration, and frequency of compression to find a compression therapy regimen that is suitable for addressing their symptoms. The system can allow for user feedback regarding efficacy of treatment. In this way, the system can compile data on what works best for a particular user. As the data is sent and stored in a remote database, the system can also collect data regarding efficacious and non efficacious treatment for larger populations. This data can be used to recommend therapies and treatments and adjust therapies and treatments for specific patients based on their specific information and demographic. Recommended therapies can include drug therapy, compression therapy, and vibration therapy. The therapies can also include electrical muscle stimulation, heat or cold therapy.

Experimental Data

Venous Flow Augmentation Compared to Commercially Available Devices

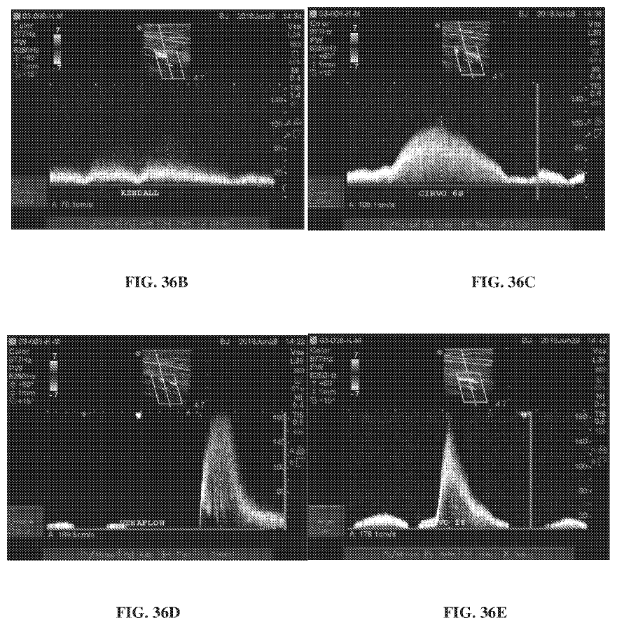

A study was done comparing the performance of a compression device of the type disclosed herein (e.g., device 300) to commercially available devices. ‘Cirvo 1’ corresponds to the device applying compression for 1 s. ‘Cirvo 3’ corresponds to the device applying compression for 3 s. ‘Cirvo 6’ corresponds to the device applying compression for 6 s. FIG. 36A displays a bar graph showing the venous flow for the various devices. FIGS. 36B-E show ultrasounds of the venous flow corresponding to the various devices with 36B showing the Kendall device, 36C showing the current device with 6s of compression, 36D showing the Venaflow, and FIG. 36E showing the current device with 1 s of compression. As shown in these figures, the compression devices disclosed herein produce more favorable results in stimulating venous flow than most of the commercially available devices, with only the Venaflow exhibiting slightly better results.

Venous Flow Augmentation in Venous Leg Ulcer Patients

This study was designed to compare peak venous velocities in venous leg ulcer patients using the mechanical compression device of the type disclosed herein (e.g., device 300) and commercially available intermittent pneumatic compression devices. Ten patients meeting inclusion/exclusion criteria and with CEAP 3-6 venous insufficiency were enrolled into an IRB approved study of venous flow augmentation. One subject was excluded secondary to failed DVT screening. Nine patients underwent measurement of peak venous velocity at baseline and with the mechanical compression device at a low and high setting. Five patients underwent an additional measurement of peak venous velocities while wearing a commercially available pneumatic compression device (Actitouch®, Tactile Medical, Minneapolis Minn.). The mechanical compression device was programmed to deliver rapid intermittent compression at two pressure settings: Low (average pressure of 38 mm HG) and High (average pressure of 52 mm Hg). The commercially available pneumatic compression device has a single setting that was used in this study. The primary endpoint for the study was augmentation of venous blood flow as measured by peak venous velocity. Average and ranges of peak venous velocities are reported in Table 2.

TABLE 2
Average and Range of Peak Venous Flow Augmentation

| | Average and range of | Average and range of |
|---|---|---|
| | Peak Venous Flow | Peak Venous Flow |
| | Augmentation | Augmentation |
| | measured at | measured at |
| | Popliteal Vein (cm/s) | Femoral Vein (cm/s) |
| Baseline | 11.1 (1.0-17.5) | 13.5 (9.9-16.7) |
| Pneumatic Compression | 14.1 (4.5-18.1) | 19.2 (13.4-25.1) |
| Device | | |
| Mechanical Compression | 56.6 (41.1-67.3) | 45.5 (30.5-60.1) |
| device - low setting | | |
| Mechanical Compression | 58.3 (42.9-77.4) | 47.1 (32.0-56.3) |
| device - high setting | | |

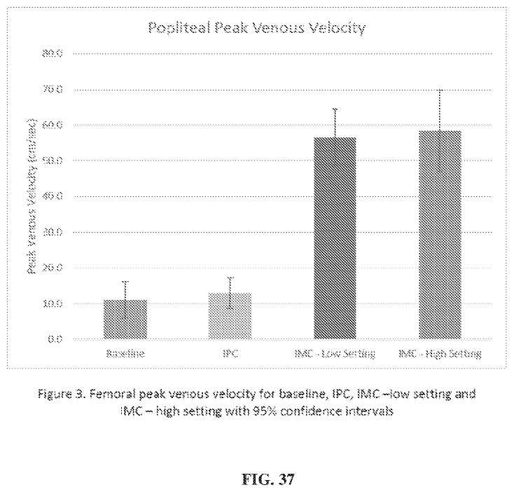

As shown in Table 2 and FIG. 37, the venous flow augmentation measured at the popliteal vein using the mechanical compression device was 56.6 cm/s at the low setting and 58.3 cm/s at the high setting from a baseline of 11.1 cm/s. Compare these values to the flow augmentation of 14.1 cm/s from a baseline of 11.1 cm/s caused by the pneumatic compression device. The venous flow augmentation measured at the femoral vein using the mechanical compression device was 45.5 cm/s at the low setting and 47.1 cm/s at the high setting from a baseline of 13.5 cm/s. Compare these values to the flow augmentation of 19.2 cm/s from a baseline of 13.5 cm/s caused by the pneumatic compression device. These results show that the mechanical compression device provided much more effective venous flow augmentation than the commercially available pneumatic compression device.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for providing compression therapy to a body part of a user, the system comprising:
a wearable compression device, the wearable compression device comprising:
a drive unit configured to be placed over or against a body part, the drive unit comprising;
one or more motors;
a controller configured to control operation of the one or more motors;
a power source in electrical communication with the one or more motors and the controller,
one or more compression members configured to be wrapped at least partially around a portion of the body part, wherein the one or more compression members are configured to be tensioned by the one or more motors; and
a housing configured to enclose the one or more motors, the controller, and the power source.

2. The system of claim 1, further comprising a handheld computing device configured to communicate with the wearable compression device.

3. The system of claim 2, wherein the handheld computing device is a smartphone.

4. The system of claim 2 or 3, wherein the handheld computing device has a touch screen user interface.

5. The system of claim 4, wherein the touchscreen user interface comprises a display with a plurality of graphical icons along an edge of the display.

6. The system of claim 5, wherein the graphical icons each link to a unique screen.

7. The system of claim 6, wherein the unique screens include a prescription screen, wherein the prescription screen is configured to allow one or more treatment parameters to be set by the user.

8. The system of claim 6 or 7, wherein the unique screens include a user treatment screen configured to allow the user to initiate, stop, and/or adjust treatment.

9. The system of claim 6, wherein the wearable compression device further comprises one or more sensors, wherein the unique screens further include a treatment data screen configured to graphically display data collected by the one or more sensors.

10. The system of claims 6-9, wherein the unique screens includes an alerts screen.

11. The system of claims 6-10, wherein the unique screens includes a user compliance screen.

12. The system of claims 4-11, wherein the touchscreen user interface has a photo section configured to allow for uploading of user photos.

13. The system of claims 4-12, wherein the touchscreen user interface comprises a user feedback section configured to allow a user to provide feedback regarding treatment.

14. The system of claims 4-13, wherein the touchscreen user interface comprises a notes section configured to allow for adding and viewing of notes.

15. The system of claims 4-14, wherein the unique screens include a treatment screen showing treatment status, treatment progress, and allows treatment control.

16. The system of claims 4-15, wherein the unique screens include a history screen showing historical treatment and/or compliance information.

17. The system of claims 4-16, wherein the unique screens include an account screen showing patient information and account settings.

18. The system of claims 1-17, wherein the device comprises a communications module.

19. The system of claims 1-18, wherein the device is configured to send data regarding treatment, compliance, efficacy and/or sensor data to a remote database.

20. The system of claim 19, further comprising a clinician interface configured to display the data received from the device.

21. The system of claim 20, wherein the clinician interface comprises an app or other software based program.

22. The system of claim 20-21, wherein the clinician interface allows for viewing of sensor and compliance data from one or more wearable compression devices.

23. The system of claim 20-22, wherein the clinician interface allows for entry or updating of prescription information.

24. The system of claims 20-23, wherein the clinician interface allows for sending messages and alerts to the user.

25. The system of claim 20, further comprising a processor configured to receive and analyze treatment data from a plurality of users and recommend a specific treatment protocol for a specific user based on the specific user's information.

26. The system of claims 1-25, wherein the devices comprises a force sensor configured to measure force in the body part.

27. The system of claim 26, wherein a processor receiving data from the force sensor is configured to detect a deep vein thrombosis in a user based on data received from the force sensor.

28. The system of claim 27, wherein the system is configured to produce an alert upon detection of the deep vein thrombosis.

29. The system of claims 1-28, wherein the device comprises a vibrating element.

30. The system of claims 1-29, wherein the device comprises an accelerometer.

31. The system of claims 1-30, wherein the wearable compression device comprises a cushioned cradle surrounding at least a portion of the housing.

32. The system of claim 31, wherein the one or more compression members extend through or over the cradle.

33. The system of claim 32, wherein the one or more compression members extend from the housing to a strap connected either side of the cradle.

34. The system of claim 33, wherein a resilient and waterproof boot enclosure is positioned between each strap and the cradle.

35. The system of claims 1-31, wherein a force sensor and/or vibrating element are positioned on a back surface of the housing.

36. The system of claim 35, wherein the cradle comprises a recessed portion configured to receive a back surface of the housing.

37. The system of claim 33, wherein the straps are reversibly secured together using one or more magnetic clasps.

38. The system of claim 37, wherein each clasp comprises a male portion on a first strap and a female portion on a second strap.

39. The system of claim 38, wherein the male portion comprises an overhang configured to be secured in an undercut of the female portion.

40. The system of claim 37, wherein a cushioned backing component is positioned around the magnetic clasp on each strap, the cushioned backing component configured to be positioned between the user's skin and the magnetic clasp during use.

41. The system of claim 40, wherein the male portion is configured to lock into the female portion when a circumferential tension is applied, and wherein the male portion is configured to be removed from the female portion by the application of inward radial force on the magnetic clasp.

42. The system of claims 1-41, the device further comprising a plurality of pulleys, one or more drive elements configured to be tensioned by the one or more motors, wherein the one or more drive elements are threaded around the plurality of pulleys.

43. The system of claim 42, wherein the one or more compression members is attached to the pulleys and configured to be tensioned by the pulleys.

44. The system of claims 1-43, wherein the one or more compression members includes a safety breakaway feature that is configured to break apart when subjected to a predetermined amount of force.

45. The system of claim 44, wherein the safety breakaway feature is a breakable clasp.

46. A device for providing compression therapy to a body part of a user, the device comprising:
a drive unit configured to be placed over or against a body part, the drive unit comprising;
one or more motors;
a controller configured to control operation of the one or more motors;
a power source in electrical communication with the one or more motors and the controller; and
a plurality of pulleys;
one or more drive elements configured to be tensioned by the one or more motors, wherein the one or more drive elements are threaded around the plurality of pulleys;
one or more compression mechanisms configured to be wrapped at least partially around a portion of the body part, wherein the one or more compression mechanisms are attached to the pulleys and are configured to be sequentially tensioned by the pulleys; and
one or more boot enclosures, each boot enclosure enclosing a portion of the one or more drive elements, wherein the one or more boot enclosures are configured to take up slack in the one or more drive elements.

47. A method for applying mechanical compression therapy to a body part of a user, the method comprising
placing a device on the body part of the user, the device comprising one or more motors, a controller configured to control operation of the one or more motors, a power source in electrical communication with the one or motors and the controller;
wrapping straps of the device at least partially around the body part of the user;
removably securing the straps together; and
causing the controller to activate the device, thereby applying mechanical compression therapy to the body part.

48. The method of claim 47, wherein the applying mechanical compression therapy comprises powering the one or more motors, thereby applying tension to one or more compression members.

49. The method of claim 48, wherein applying tension to one or more compression members comprises tensioning one or more drive elements using the one or more motors, wherein the one or more drive elements are threaded around a plurality of pulleys and connected to the one or more compression members.

50. The method of claim 47-49, wherein causing the controller to activate the device comprises using a user interface on the device or on an app or program in electrical communication with the device.

51. The method of claim 47-50, further comprising causing the controller to send data regarding treatment, compliance or sensor data received from sensors positioned on the device to a remote database.

52. The method of claim 47-51, further comprising monitoring force in the body part using a force sensor on the device.

53. The method of claim 52, further comprising a processor receiving data from the force sensor;
processing the data using a processor; and executing algorithms on the processor configured to detect a deep vein thrombosis from the data.

54. The method of claims 47-53, further comprising sensing periodic limb movements using an accelerometer.

55. The method of claim 54, further comprising the controller initiating treatment based on sensing periodic limb movements.

56. The method of claims 47-55, further comprising the controller activating a vibrating element on the device.

57. The method of claim 56, further comprising the controller initiating compression and/or vibration based on sensing periodic limb movements.

58. The method of claims 47-57, further comprising the controller stopping the device.

59. The method of claims 47-58, further comprising uploading user data using an app or program in electrical communication with the device.

60. The method of claims 47-59, further comprising storing user data, treatment data, and/or compliance data in a remote database.

61. The method of claim 60, further comprising generating recommended therapy protocols based on the stored data.

62. The method of claim 60, wherein the data is received from a plurality of users and devices.

63. The method of claims 47-62, further comprising zeroing the device to a baseline condition.

64. A method of monitoring a patient for deep vein thrombosis (DVT), comprising
wrapping a compression device comprising a controller, a motor, and one or more compression members at least partially around a calf of a patient, the compression device comprising a force sensor positioned such that it is configured to measure tension in the patient's calf;
causing the controller to activate the device to apply compression and measure the tension in the patient's calf; and
using a processor to process data received from the force sensor, the processor configured to recognize data from the force sensor corresponding to development of a DVT in the patient.

65. The method of claim 64, further comprising the processor detecting a DVT.

66. The method of claim 65, further comprising adjusting treatment applied by the compression device upon detection of the DVT.

67. The method of claim 65 or 66, further comprising producing an alert upon detection of the DVT.

68. A method of monitoring a patient for onset of symptoms of restless leg syndrome, the method comprising
wrapping a device comprising a controller, a vibrating element, a motor, and one or more compression members in communication with the motor and and configured to apply compression, at least partially around a portion of a leg of a patient, the device comprising an accelerometer;
causing the controller to activate the accelerometer to monitor movement of the patient's leg; and
using a processor to receive data from the accelerometer, the processor configured to recognize data corresponding to periodic limb movements of the patient.

69. The method of claim 68, further comprising the processor recognizing periodic limb movements of the patient.

70. The method of claim 69, further comprising initiating compression therapy upon detection of periodic limb movements.

71. The method of claim 69 or 70, further comprising initiating vibration therapy upon detection of periodic limb movements.

72. The method of claims 69-71, further comprising modulating ongoing therapy upon detection of periodic limb movements.
